(19) United States
(12) Patent Application Publication
(10) Pub. No.: US 2007/0143578 A1
(43) Pub. Date: Jun. 21, 2007

(54) System and method for message passing fabric in a modular processor architecture

(75) Inventors: James A. Horton, New Tripoli, PA (US); Robert C. Klein Jr., Bethlehem, PA (US); George F. Gross, Fleetwood, PA (US); Terry Flemming, Macungie, PA (US); Reynolds E. Jenkins Jr., Merztown, PA (US)

Correspondence Address: ROBERT S. LIPTON, ESQUIRE, 201 NORTH JACKSON STREET, P. O. BOX 934, MEDIA, PA, 19063-0934, US

(73) Assignee: GateChange Tethnologies, Inc., Breinigsville, PA (US)

(21) Appl. No.: 10/579,085

(22) PCT Filed: Nov. 12, 2004
(86) PCT No.: PCT/US04/37761

§ 371 Date: May 12, 2006

Related U.S. Application Data
(60) Provisional application No. 60/519,129, filed on Nov. 12, 2003.
(60) Provisional application No. 60/562,908, filed on Apr. 16, 2004.

(51) Int. Cl. G06F 15/00

(52) U.S. Cl. 712/11

(57) ABSTRACT

The invention provides a system and method of providing a message passing fabric in a modular processing system where a plurality of processing elements (VFBs), access other available processing elements to provide a message passing fabric where the fabric asynchronously establishes routes for synchronous messages from an origin processing element to a destination processing element to permit an operation to occur at the destination processing element in a flexible, efficient, self-routing and real-time dynamically optimized manner.

### CROSS REFERENCE TO RELATED APPLICATIONS

This application claims benefit under 35 U.S.C. Section 119(e) from the following Provisional Applications, Provisional Application No. 60/519,129 filed Nov. 12, 2003 and Provisional Application No. 60/562,908 filed Apr. 16, 2004, of which the entire contents of both applications are herein incorporated by reference.

### BACKGROUND OF THE INVENTION

The present invention relates generally to a system and method for message based interconnect in electrical or electronic devices. More specifically, the present invention relates to a system and method for a message passing fabric in a modular processor architecture where the architecture consists of a self-routing, message-based interconnect system for electrical and/or electronic devices.

It can be appreciated that integrated circuits (chips or ICs) with various types of interconnect have been in use for years. Typical integrated circuit interconnections can be grouped into three distinct classes of on-chip interconnect. The first class is conventional microprocessor and/or microcontroller bus-type architectures. These conventional microprocessor/microcontroller bus architectures include Von Neumann type architectures—wherein address and data information are multiplexed onto a single set of metal conductors—and Harvard architectures—where separate paths are provided for the data and address signals. The second class of conventional on-chip interconnect is the programmable interconnect found in Field Programmable Gate Arrays (FPGAs) and other Programmable Logic Devices (PLDs). The third class of on-chip interconnect is the highly customized, hard-wired, device-specific wiring that is found in full-custom, Application Specific Integrated Circuits (ASICs).

The main problem with conventional integrated circuit interconnect structures is their inability to be adaptable to and dynamically optimized for a range of tasks. Another problem with conventional integrated circuit interconnect structures is their inability to be dynamically changed to precisely meet the requirements of the current task or set of tasks at hand and then be modified should the task or tasks change. While the programmable interconnect within FPGA-type devices can in theory be reconfigured, in practice this is rarely done because of the complexity of the tools required and the time lapse (“configuration latency”) associated with such changes. Another problem with conventional integrated circuit interconnect structures is that they are not well-suited for a semiconductor architecture wherein the data paths are constantly changing. Such changes are desirable in order to support real-time optimization of the circuitry and interconnect to match the needs of the task or set of tasks at hand. Furthermore, conventional fixed and programmable routing structures do not allow an array of functions—either homogenous or heterogeneous—to be quickly and easily laid out in a device such that the routing structures can be created and controlled simply by placing the functions physically (or logically) next to each other (“tiling”).

Early attempts to provide general purpose microprocessor architecture to be used in parallel computing schemes included the use of a chip known as a Transputer. Transputers were early attempts to provide high performance microprocessors that supported parallel processing through on chip hardware. They were developed by Inmos Ltd. (now St Microelectronics). Generally, a transputer included serial links that allowed it to communicate with up to four other transputers. Any number of transputers could be connected together over links to from a single computing farm. The transputer employed a stack based system having registers. There were limits to the size of the system that could be built using Transputers and sending messages to distant transputers resulted in long delays; it also required specific establishment of a logical link between nonadjacent connected processors. In addition, routes were fixed and predetermined and not able to react to the dynamics of a changing workload or access patterns. Another significant drawback to this method was the channel processor caused both the sender and receiver to be exchanging messages suspending both processors while the transfer took place.

While the interconnect structures of the prior art may be suitable for the particular purpose to which they address, they are not as suitable for providing a flexible, efficient, self-routing and dynamically optimized means for connecting together functional elements or blocks within a semiconductor device.

In these respects, a system and method for a message passing fabric in a modular processor architecture with a self-routing, message-based interconnect system for electrical and/or electronic devices according to the present invention substantially departs from the conventional concepts and designs of the prior art, and in so doing provides a method and an apparatus primarily developed for the purpose of providing a flexible, efficient, extensible, self-routing and real-time dynamically-optimized means for connecting together functional elements or blocks within a semiconductor device that is modular in approach and therefore requiring no additional circuitry for applications requiring multiple modules.

In view of the foregoing disadvantages inherent in the known types of conventional message based interconnect systems in logic devices, integrated circuits and system-level interconnect structures of the prior art, it is therefore desirable to provide a system and method for a message passing fabric in a modular processor architecture which includes a self-routing, message-based interconnect system that provides a flexible, efficient, self-routing and real-time dynamically optimized means for connecting together processing elements or blocks, for example within an integrated circuit device, such as a-semiconductor device and/or other electrical or electronic system.

### SUMMARY OF THE INVENTION

The present invention provides a programmable logic device, more specifically a programmable integrated circuit interconnect system and method. The present invention provides for a system and method of providing a message passing fabric in a modular processing system that comprises generally a plurality of processing elements, or VFBs, which are configured to access other available processing elements. The processing elements of the present invention communicate with a plurality of message ports, or busses, such that message ports on adjacent, which does not necessarily mean physically adjacent, processing elements define a message path between the processing elements. Each message port associated with a prioritization means for determining which message port is to be given access to an associated processing element or message port. Each processing element of the present invention associated with an addressing means for indicating the destination of a message in the fabric and a prioritization means for determining which message port is to be given access to an associated processing element or message port where the fabric asynchronously establishes routes for synchronous messages from an origin processing element to a destination processing element to permit an operation to occur at the destination processing element.

### BRIEF DESCRIPTION OF THE DRAWINGS

FIG. 1 is a block diagram of an exemplary messenger interconnected processor Array.

FIG. 2 provides a block diagram of an Individual VFB.

FIG. 2A provides an alternative embodiment of a block diagram of an individual VFB of the present invention.

FIG. 3 illustrates the various sub-blocks that combine to form an individual VFB, and the signals that interconnect these blocks.

FIG. 3A illustrates an alternative embodiment of the present invention of the various sub-blocks that combine to form an individual VFB, and the signals that interconnect these blocks.

FIG. 4 provides a block diagram of alternative preferred embodiment of an Individual VFB.

FIG. 5 illustrates a Local Messenger Port.

FIG. 6 illustrates a Local Messenger.

FIG. 7 illustrates a Long Distance Messenger Port.

FIG. 8 shows the Long Distance Messenger Port Control Logic.

FIG. 9 illustrates the Long Distance Messenger.

FIG. 10 illustrates how Request and Busy Information is shared among Long Distance Port Controls.

FIG. 11 shows a Long-Distance Message Connection with no path contention.

FIG. 12 illustrates A Long Distance Message Connection, but with path contention and without Deny.

FIG. 13 shows a Long Distance Message Connection, but with Path Contention and with Deny.

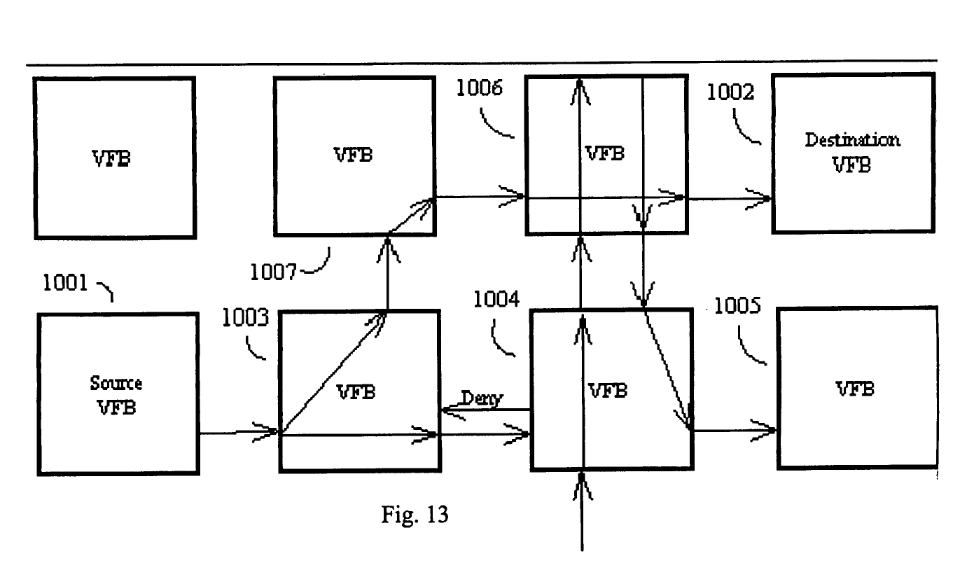

FIG. 14 illustrates a flow diagram of a preferred embodiment of a bridge single port, optimistic send operation.

FIG. 15 illustrates a flow diagram of a preferred embodiment of a bridge single port, pessimistic send operation.

FIG. 16 illustrates a flow diagram of a preferred embodiment of the present invention having a dual send port bridge.

FIG. 17 illustrates a flow diagram of a preferred embodiment of the bridge receive (optimistic) operation.

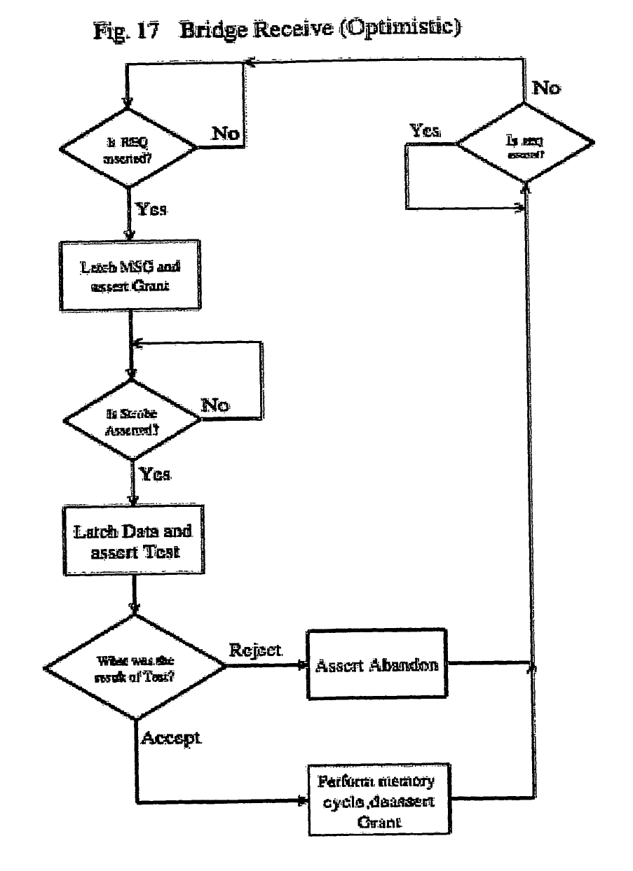

FIG. 18 illustrates a flow diagram of a preferred embodiment of the bridge receive (pessimistic) operation.

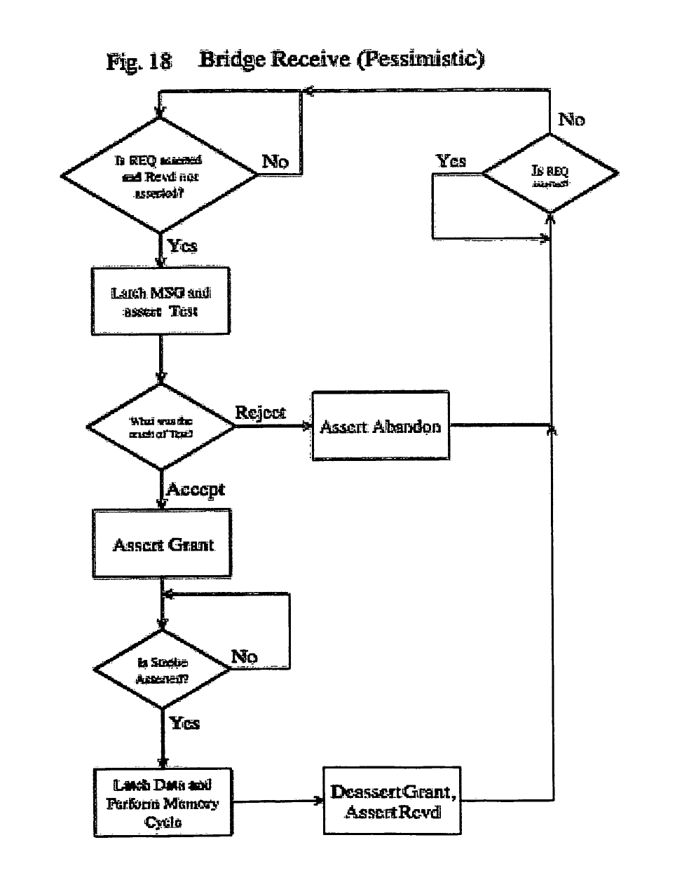

### DETAILED DESCRIPTION OF THE PREFERRED EMBODIMENTS

Throughout the figures provided, numbering is preserved such that a reference number appearing in more than one figure refers to the same object. Arrows within the figures refer to the primary direction of the flow of control and data and should not be construed as the sole direction of data flow.

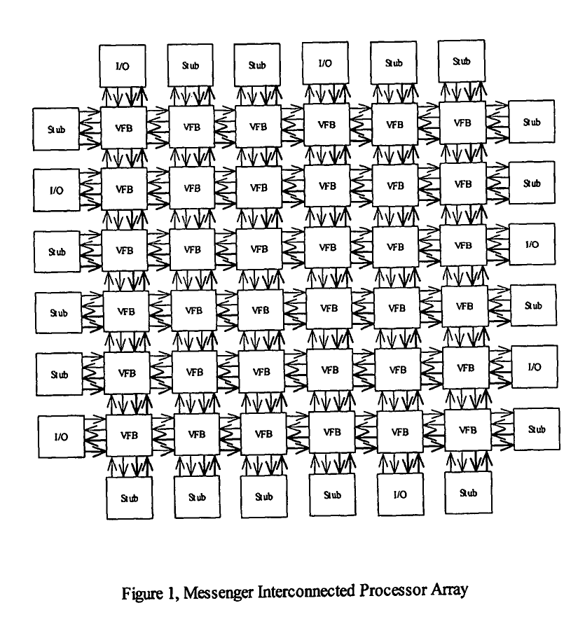

Referring now to the Figures, various preferred embodiments of the present invention are shown. Generally, as illustrated in FIG. 1, the modular processor architecture of the present invention comprises at least one processing element. More preferably the architecture comprises a plurality of processing and/or logic elements 101(also known as Virtual Function Blocks or VFBs, and hereinafter referred to as VFBs) configured to be interconnected according to a preferred message passing fabric system and method. In a plurality of preferred embodiments of the present invention, the processing and/or logic elements, VFBs (101) to be interconnected, are configured to interconnect with message ports (102). According to preferred embodiments of the present invention, the message ports include a series of primary and secondary groups (busses) of interconnect paths including Local and/or Long Distance busses (102) with separate signal paths for data, address, and/or control signals; and Arbitration and Control Circuitry.

Preferably, the VFB includes one or more of the following components or any combination thereof: Central Processing Units (CPU), Arithmetic Logic Units (ALU); Memory Elements (MEM); Arbitrary Function Generators (ARB); State Machines; Digital Signal Processors (DSP); Analog Signal Processors (ASP); Programmable Logic Devices (PLD including Field Programmable Gate Array (FPGA) and Complex PLD (CPLD)); Input and/or Output (I/O) elements; and/or General Purpose logic. The array of VFBs can either be homogeneous or heterogeneous. The above list of components and combination of components for the VFBs is not meant to limit the components or any combination thereof for a VFB of the present invention to only those listed above. Additional components or combinations components may be included on a VFB in accordance with the present invention. Generally, The type of VFBs or processing element blocks being interconnected is not limited by the scope of this invention; Preferably, the present invention relates to the method and system of dynamically interconnecting the VFBs through a message passing fabric where the fabric is comprised of homogeneous and/or heterogeneous processing element, VFBs, and/or multiple sets or combinations thereof of processing elements, VFBs. More preferably the architecture comprises a plurality of processing and/or logic elements, VFBs, which are selected to be interconnected according to the computational characteristics of the computational task to be preformed by the message passing fabric of the present invention. The computational task to be performed may be predetermined or dynamically determined in accordance with the present invention.

Arbitration and Control Circuitry is also associated with the VFB, as are ports which physically connect the VFBs to the message ports or interconnect busses described below.

Referring to FIG. 1, the invention consists of a two-dimensional array (100) of processing elements, referred to as Virtual Function Blocks or VFBs (101), interconnected by message passing ports (102) that provide connections between adjacent VFBs one or more bi-directional paths. In preferred embodiments of the present invention, The VFB is interconnected by message passing ports (102) that provide connections between adjacent VFBs through selection of either or both two distinct, bi-directional paths, the local and long distance connection paths, or local and long distance message ports. The term adjacent, throughout this description, refers to the connection relationship between VFBs and not necessarily their physical orientation to each other. For example, interleaving the local and long distance connections between VFBs such that the connections pass over physically adjacent VFBs results in VFBs that are not physically adjacent being connected adjacently for the purpose of this description. For simplicity in this description, adjacent VFBs are also physically adjacent VFBs. As disclosed, the preferred embodiments of the present invention refer to a two-dimensional array (100) for purposes of illustration only. The disclosure is not intended to be limited to two-dimensional arrays. The teachings of this application can be applied to arrays of two or more dimensions including multi-dimensional arrays.

The Message Ports (102), include interconnect busses which provide the physical connections over which data—including, by way of example but not limited to, applications data, addressing, control, program, and signaling information—is passed between one or more VFBs. In accordance with preferred embodiments of the present invention, the Message ports interconnect busses are broken into two types; the Local messenger ports having local busses and the Long Distance messenger ports having long distance busses.

In a first alternative preferred embodiment, Each VFB has both input and output Long Distance messenger ports comprising busses for each of the four directions for a total of 8 Long Distance messenger port busses. In this preferred embodiment, the present invention utilizes but is not limited to twelve dedicated bus structures for the Local messenger ports busses, or nearest neighbor connections. In this particular preferred embodiment, the Local messenger port busses operate independently from the Long Distance messenger port busses structures and serve primarily to offer dedicated, high-bandwidth communications between neighboring VFBs. In this preferred embodiment, the utilization of the Local busses minimizes the traffic that must traverse the Long Distance networks. In this embodiment a total of 8 Long distance messenger port busses in a two-dimensional array is presented, higher order multi-dimensional array implementations are to be considered within the scope of this patent

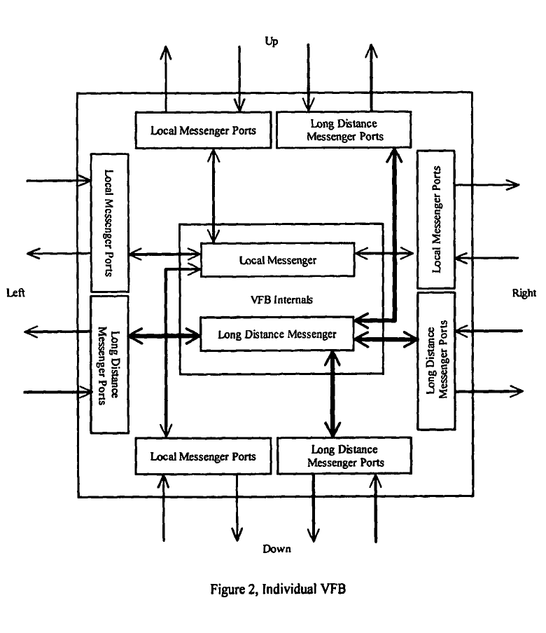

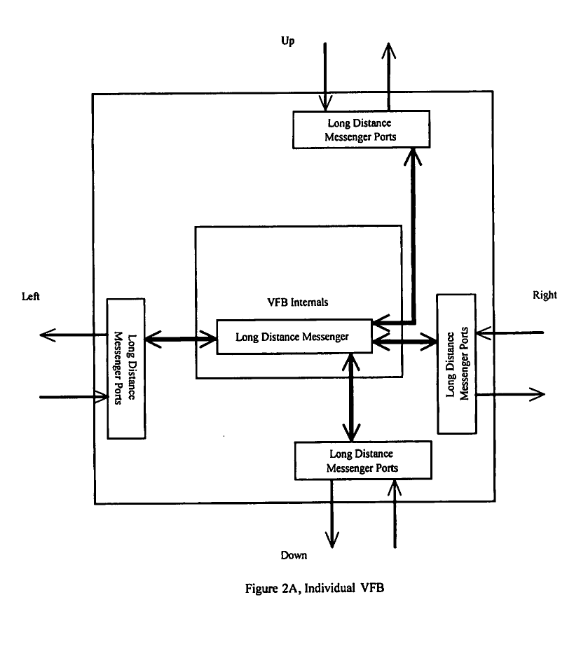

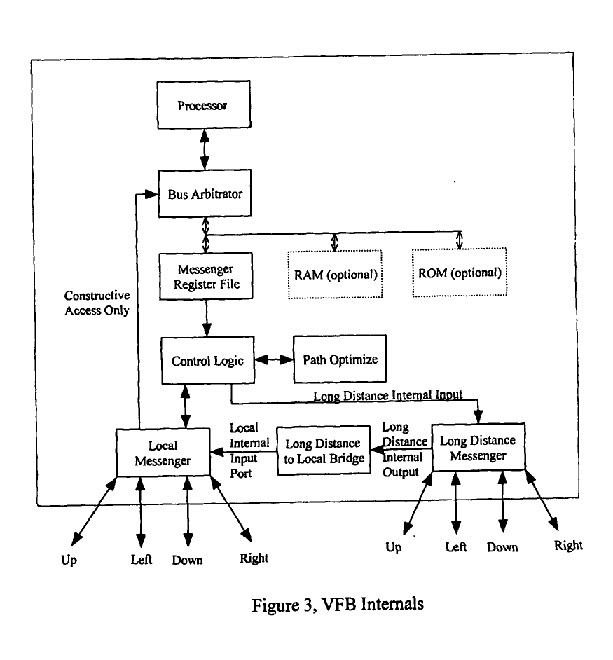

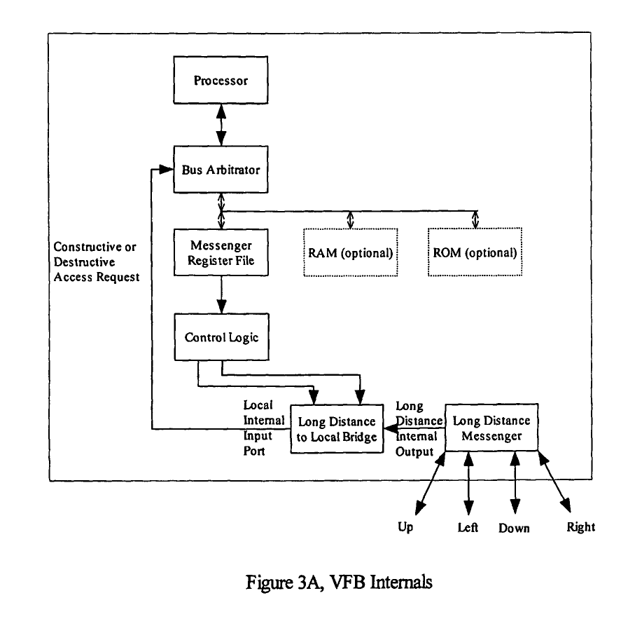

In a second alternative preferred embodiment, each VFB has both input and output Local and Long Distance messenger ports comprising busses for each of four generalized physical directions for a total of eight Local and eight Long Distance messenger port busses. In this alternative preferred embodiment, the Local messenger port buss structures operate in conjunction with the Long Distance messenger port bus structures to provide dedicated, high-bandwidth communications between physically and/or logically neighboring VFBs in the array, as illustrated in FIGS. 2 and 3. Again, as stated above although a two-dimensional array is presented, higher order multi-dimensional array implementations are to be considered within the scope of this patent.

In a third alternative preferred embodiment, each VFB has long distance messenger ports comprising input and output Long Distance buss structures configured to operate without (one or more/any) local messenger ports. In this preferred embodiment, the local messenger ports buss structures (201, 202, and 203,204) and Local messenger unit (209) is removed from configuration with the VFB, thereby resulting in less required physical connections between multiple VFBs; as illustrated in FIGS. 2A and 3A. In this preferred embodiment, the method and system by which the VFB sends a message remains similar to the alternative embodiment discussed above,( where the Local messenger port buss structures operate in conjunction with the Long Distance messenger port bus structures to provide dedicated, high-bandwidth communications between physically and/or logically neighboring VFBs in the array) all of which will be discussed in more detail below

In accordance with the preferred embodiments of the present invention, the Arbitration and Control Circuitry performs generally three distinct functions. First, the Arbitration and Control Circuitry is responsible for formatting Message requests that originate in a given VFB and forwarding these Messages accordingly, thereby providing an addressing means for association with each vfb for indicating the destination of a message in the message passing fabric. Second, the circuitry functions to detect incoming messages from other VFBs and to determine the availability of a path that would move the incoming message closer to its destination, thereby providing a prioritzation means for association with each vfb and each message port for determining which message port is to be given access to the associated processing element or message port. If more than one path exists, the circuitry according to this function selects one of the available paths according to the prioritization scheme of that preferred embodiment, Third, the Arbitration and Control Circuitry functions to determine if an incoming message has reached its destination, by determining/signaling the availability of the destination resource requested in the Message. In accordance with the preferred embodiments of the present invention, if the destination resource is indeed available—placing the Message payload (data) into the requested resource and signaling the completion of this transaction; if the destination resource requested is not available, this is signaled back through the established path to the source of the request. Preferrably, the message passing fabric of the present invention asynchronously establishes routes for synchronous messages from an origin processing element to a destination processing element thereby permitting an operation to occur at the destination processing element.

Referring now to FIG. 2, a more detailed view of a VFB (101) and its interconnections, is illustrated. Local messenger ports connect between adjacent VFBs in the right (201), down (202), left (203) and up (204) directions. Similarly, long distance messenger ports connect between adjacent VFBs in the right (205), down (206), left (207) and up (208) directions. The local messenger ports are used to relay messages between adjacent source and destination VFBs in any of the orthogonal directions; up, down, left or right. The long distance messenger ports are similarly connected between adjacent VFBs, but contain additional addressing information that is used and manipulated by each VFB to construct a path spanning multiple VFBs. Although a two dimensional array is illustrated for the local and long distance messenger ports, the same configuration can be applied in an array have two or multiple dimensions. Such multi-VFB paths dynamically create a connection between source, or origin, and destination VFBs within the array that are non-adjacent. A source, or origin, VFB is considered to be a sender of a message containing control or data to be stored in a destination VFB. The location of the destination VFB and the storage location of the message contents within the destination VFB are controlled by the source VFB. Local messages are sent and received by a local messenger unit (209) using the local messenger ports (201, 202, 203 and 204) contained within a VFB. Long distance messages are sent and received by a long distance messenger unit (210) using the long distance messenger ports (205, 206, 207 and 208) contained within a VFB. Both the local messenger (209) and long distance messenger (210) are contained within the VFB internals (211). Each VFB (101) is specifically designed to be modular, so that no additional logic is required to connect adjacent VFBs together, permitting larger or smaller arrays of VFBs to be readily constructed.

Referring to FIG. 2A, a more detailed view of an alternative preferred embodiment of VFB (101) and its interconnections is illustrated. In an alternative preferred embodiment of the present invention the local messenger ports are removed from the configuration of the VFB (101). In this preferred embodiment, the long distance messenger ports connect between adjacent VFBs in the right (205), down (206), left (207) and up (208) directions. The long distance messenger ports are connected between adjacent VFBs, and contain additional addressing information that is used and manipulated by each VFB to construct a path spanning multiple VFBs. In this embodiment the long distance messenger ports are also used to relay messages between adjacent source and destination VFBs in any of the orthogonal directions; up, down, left or right Again, although a two dimensional array is illustrated for the long distance messenger ports, the same configuration can be applied in an array having two or multiple dimensions. Such multi-VFB paths dynamically create a connection between source, or origin, and destination VFBs within the array that are non-adjacent. A source, or origin, VFB is considered to be a sender of a message containing control or data to be stored in a destination VFB. The location of the destination VFB and the storage location of the message contents within the destination VFB are controlled by the source, or origin, VFB. In this preferred embodiment all messages are sent and received by a long distance messenger unit (210) using the long distance messenger ports (205, 206, 207 and 208) contained within a VFB. In this preferred embodiment the long distance messenger (210) is contained within the VFB internals (211). Each VFB (101) is specifically designed to be modular, so that no additional logic is required to connect adjacent VFBs together, permitting larger or smaller arrays of VFBs to be readily constructed. The preferred embodiments illustrated in FIGS. 2A and 3A will be discussed in further detail below.

Referring now to FIG. 3, in this preferred embodiment, within the VFB internals (211) is a messenger register file (301), constructed as an array of discrete registers that serves as a portal through which messages are sent to and received by adjacent or non-adjacent VFBs. The register file (301) is connected via a bus arbitrator (302), to a processor (303) that may consist of a CPU, DSP, FPGA, mask PGA and/or any other logic element capable of accessing the registers contained within the messenger register file (301). The register file is also connected to control logic (304) that has continuous access to the messenger register file (301), independently from the bus arbitrator (302). The bus arbitrator (302) and the control logic (304) are capable of accessing the register file concurrently, including when accessing the same register.

Each register within the register file (301) has associated with it a presence bit that indicates the presence (asserted) or absence (not asserted) of data or control information within the register. Each register may be accessed and manipulated in one of three fundamental ways; constructively, passively or destructively. A constructive access is one in which the register is filled with control or data information, causing the presence bit associated with the register to be asserted. A passive access is one in which the contents of the register is inspected but the presence bit associated with the register is left unchanged. A destructive access is one in which the register contents are inspected and the presence bit associated with the register is caused to be not asserted. For any access to a register within the register file, the register file presents the state of the presence bit associated with the register to the accessor so that a signal causing the accessor to wait (halt), suspend or retry may be generated if the access is inhibited.

A constructive access to a register within the register file is inhibited if the presence bit associated with the register is currently asserted. A passive or destructive access to a register within the register file is inhibited if the presence bit associated with the register is currently cleared. The preferred action of the processor (303) to an inhibited access to a messenger register (301) is to wait.

The processes of permitting the processor (303) to wait while still permitting constructive access to the register file by the messages received through the message passing fabric is accomplished by a memory bus arbitrator (302). The memory bus arbitrator selects between competing accesses from the processor (303) and incoming data from the message-passing fabric arriving through the local messenger (305). In the preferred embodiment illustrated in FIG. 3A The system and method selects between competing accesses from the processor (303a) and incoming data from the message-passing fabric arriving through the long distance messenger (313a).

As illustrated in FIGS. 3 and 3A, a prioritization means associated with each processing element, VFB, and each message port is provided for determining which message port is to be given access to an associated processing element or message port

Referring now to FIG. 3, the memory bus arbitrator gives priority to the local messenger (305), causing the next available messenger register file access to be granted to the local messenger, while concurrently providing a wait signal to the processor (303). In the event that the processor (303) is already engaged in an inhibited access to the register file when the local messenger (305) is also in need of a register file access, the memory bus arbitrator continues to present a wait signal to the processor while transferring control of the address and Data lines to the register file (301) to the local messenger (305). Once the local messenger has completed its access to the messenger file, control of the address and data lines is returned to the processor (303). An access to the messenger register file (301) via the bus arbitrator (302) by the local messenger (305) is never inhibited, thus the local messenger, normally, will not begin an access to the register file unless it has confirmed in advance of requesting the access, via control logic (304), that the access will not be inhibited. The preferred embodiment of FIG. 3A will be discussed in more detail below.

The following is a detailed listing of the individual registers that collectively form the messenger register file (302) within a VFB, and exemplary addressing within the processor (303) memory space.

TABLE 1
Messenger Register File

| | Base Address | Register Index | |
|---|---|---|---|
| Messenger Register | (Hex) | (Hex) | Description |
| CONFIG | 10000 | 0 | VFB Config Info |
| FAULT | 10004 | 1 | Crypto Fault Actions |
| PKEY | 10008 | 2 | Crypto Key Register |
| LOCATOR | 1000c | 3 | Locator VFB address |
| DLINK | 10010 | 4 | Crypto Decrypt Link Register |
| DECRYPT | 10014 | 5 | Crypto Decrypt Register |
| ELINK | 10018 | 6 | Crypto Encrypt Link Register |
| ENCRYPT | 1001c | 7 | Crypto Encrypt Register |
| VMSG | 10020 | 8 | VMSG Vector Register |
| M1 . . . M15 | 10024 | 9 . . . 17 | General Purpose Messages |
| Reserved | 10060-78 | 18 . . . 1e | M Register Expansion |
| MPRES | 1007c | 1f | Message Presence Bits |
| MSENDA | 10080 | 20 | Message Send Address |
| MDATAW | 10084 | 21 | Message Send Data |
| MDATAR | 10088 | 22 | Message Rcv Data |
| Reserved | 1008c | 23 | Reserved |
| LRIGHTA | 10090 | 24 | Local Message Send Right Reg Addr |
| LRIGHTW | 10094 | 25 | Local Message Send Right Data |
| LDOWNA | 10098 | 26 | Local Message Send Down Reg Addr |
| LDOWNW | 1009c | 27 | Local Message Send Down Data |
| LLEFTA | 100a0 | 28 | Local Message Send Left Reg Addr |
| LLEFTW | 100a4 | 29 | Local Message Send Left Data |
| LUPA | 100a8 | 2a | Local Message Send Up Reg Addr |
| LUPW | 100ac | 2b | Local Message Send Up Data |
| Reserved | 100b0-f8 | 2c . . . 3e | Reserved |
| MSTATUS | 100fc | 3f | Messenger Status Bits |

Messenger Register Descriptions

The messenger registers from 10000 hex to 100ff hex are shadowed (not physically) at addresses 10100 hex to 101ff hex. When a register is read in the address range 10000 hex to 100ff hex, the access is passive as described previously. When a register is read in the addresses range 10100 hex to 101ff hex, the access is destructive, causing the presence bit of the register to be cleared. All write accesses to the messenger register file are constructive.

Referring to Table 1, the following is an overview of the general structure and function of selected individual registers within the messenger register file that are pertinent to the description of preferred embodiments of the present invention.

MPRES—Message Presence Bits

Referring to Table 1, each messenger register within the register index range of 0 to 1 f hex has the status of its associated presence bit reflected in the 32 bit contents of the MPRES register. There is a direct correlation between register index value (Table 1) and bit position within the MPRES register, with register index 0 represented by the least significant bit of MPRES and register index 1f hex represented by the most significant bit of MPRES. Access to the MPRES register, regardless of type (constructive, passive or destructive), never results in the access being inhibited. During a constructive access, asserting any bit position of this register causes the corresponding presence bit it represents to be not asserted.

MSENDA—Message Send Address

Referring to Table 2, the MSENDA register contains a description of where a source, or origin, VFB is requesting to send a message, including the location within the destination where the contents of the message is to be placed thereby providing an addressing means associated with each processing element, VFB for indicating the destination of a message via/through the message passing fabric The Register Index field describes the messenger register into which the message data is to be placed. Row Offset, Column Offset, Row Negative and Column Negative combined describe the relative position of the destination VFB relative to this VFB. A row is considered a left-right sequence of adjacent VFBs within the array (100) and a column an up-down sequence of adjacent VFBs within the array (100). The teachings of the row and column of Table 2 are not intended to limit the scope of this invention to two dimensional arrays with two axes, higher order multi-dimensional arrays having two or more multi-axis implementations are to be considered within the scope of this patent. Interrupt is used as an optional means to signal the destination VFB upon the arrival of message data from the source VFB. Force, also optional, provides a means for the source VFB to signal the destination VFB to ignore the presence bit of the desired register within the destination VFB, thus allow a transfer that would might otherwise be inhibited to be performed. Burst causes a source and destination VFB to remain connected after the first transfer, rather than causing the connection to be re-established for each transmission of message data.

TABLE 2
MSENDA Register Bit-field Definitions

| Name | Bits | Description |
|---|---|---|
| Register | 0:5 | Register index within the destination VFB |
| Index | | |
| Column | 6:6 | Destination VFB relative column direction, not |
| Negative | | asserted for right, asserted for left |
| Row | 7:7 | Destination VFB relative row direction, not asserted |
| Negative | | for down, asserted for up |
| Column | 8:15 | Two's complement of the absolute destination VFB |
| Offset | | col. offset |
| Row Offset | 16:23 | Two's complement of the absolute destination VFB |
| | | row offset |
| Interrupt | 24:24 | If asserted, interrupts the destination processor after |
| | | transfer |
| Force | 25:25 | If asserted, ignores the state of the presence bit |
| | | associated with the destination VFB Register |
| Burst | 26:26 | If asserted, remains connected after the first transfer |
| Reserved | 27:31 | Not used |

MDATAW—Message Send Data

MDATAW contains the data to be placed into the destination VFB register indicated by the contents of the MSENDA register.

LRIGHTA—Local Message Send Right Register Address

Referring to Table 3, the LRIGHTA register contains the address of the location with the destination where the contents of the message is to be placed.

Its structure and field meanings are identical the MSENDA register except that it does not contain row and column address information because it is only used to describe a transfer to the destination VFB that is adjacent to the right, using the local messenger. Burst is also not used, as the local messenger has a dedicated local messenger connection to the right and thus there is no connection path to dynamically construct. LDOWNA, LLEFTA and LUPA are identical in function and differ only with regard to the direction of the destination.

TABLE 3
LRIGHTA Register Bit-field Definitions

| Bits | Description |
|---|---|
| 0:5 | Messenger space register index of peer VFB |
| 6:23 | Ignored |
| 24:24 | 1=Interrupt |
| 25:25 | 1=Force |
| 26:31 | Ignored, must be zero |

LRIGHTW—Local Message Send Right Data

LRIGHTW contains the data to be placed into the destination VFB register indicated by the contents of LRIGHTA. LDOWNW, LLEFTW and LUPW are identical in function and differ only with regard to the direction of the destination.

MSTATUS—Messenger Status Bits

Referring to Table 1, each messenger register within the register index range of 20 hex to 3f hex, has the status of its associated presence bit reflected in the 32 bit contents of the MSTATUS register. There is a direct correlation between register index value (Table 1) and bit position within the MSTATUS register, with register index 20 hex represented by the least significant bit of MSTATUS and register index 3f hex represented by the most significant bit of MSTATUS. Access to the MSTATUS register, regardless of type (constructive, passive or destructive), never results in the access being inhibited. During a constructive access, asserting any bit position of this register causes the corresponding presence bit it represents to be not asserted.

Local Message Transmission

Referring again to the preferred embodiment illustrated in FIG. 3, the process of sending a local message from an origin, or source, VFB to a destination VFB—in this example an adjacent VFB to the right—begins with the processor (303) of the source VFB performing a constructive write access to local messenger register LRIGHTA in the messenger register file (301). The register index portion of LRIGHTA indicates the specific register to be written within the adjacent VFB to the right. This is followed by the processor (303) performing a constructive write access to local messenger register LRIGHTW with the control or data to be transferred into the destination VFB. As a result of these two constructive accesses, the presence bits associated with the LRIGHTA and LRIGHTW registers have been asserted. In the preferred embodiment, performing a constructive access to the LRIGHTW register also causes the presence bit associated with the LRIGHTA register to be asserted concurrently. This is done to facilitate repetitive message transfers without having to perform an additional constructive access to the LRIGHTA register for each transmission.

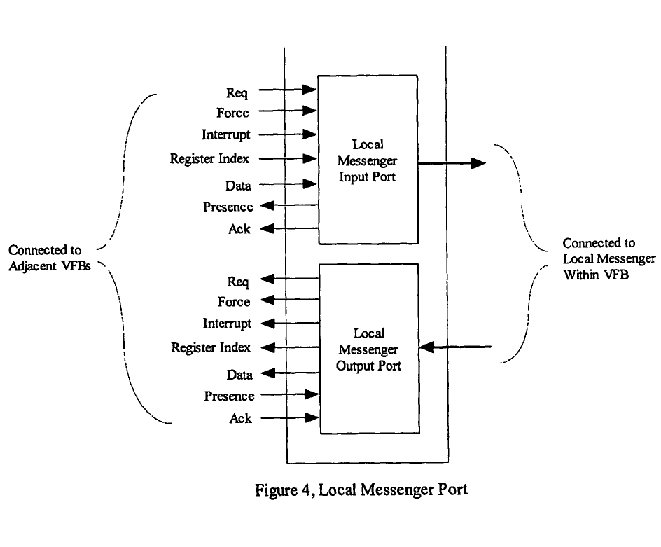

The control logic (304) of the source VFB, upon detecting that the presence bits associated with the LRIGHTA and LRIGHTW registers are asserted, transfers the Register Index, Force and Interrupt portions of the LRIGHTA register to the local messenger port (201) that exits the right side of the source VFB and enters the left side of the destination VFB (203). Referring to FIG. 4, the signals of a local messenger port are shown in greater detail. Thus messenger port (400) is a more detailed view of each of local messenger ports (310, 201, 202, 203 and 204). The signals of these port consist of a Req line (410), Register Index bus (425), a Presence line (435), Force line (415), Interrupt line (420), Data bus (430) and Ack line (440). One set of these lines is fed to an adjacent VFB by an output port (402) and the other identical set is fed from the same adjacent VFB into an input port (401). Thus, each port is a bi-directional connection to an adjacent VFB that utilizes discrete paths. A source VFB will transfer out of the VFB through the output port (402) that feeds in the direction of the destination VFB, to a destination VFB that transfers in using the input port (401) fed from the direction of the source VFB. In this example - a local transmission to the right—the source VFB uses the local port (201) to communicate with the local port (203) of the destination VFB.

Referring to the local messenger port (400), Req (410) is driven by a source VFB, and while asserted, the Register Index (425), Interrupt (420) and Force lines (415) of the port are assured valid and propagated to the adjacent VFB. Req remains asserted until the destination VFB has completed the transfer, signaled by the assertion of the Ack line by the destination VFB. When the source VFB is not asserting Req, the destination VFB causes Ack to be not asserted.

Also referring to the local messenger port (400), Register Index (425) is driven by the source VFB to indicate to the destination VFB the messenger register to which a constructive access is required. Presence (435) is driven by the destination VFB to indicate the state of the presence bit associated with the messenger register within the destination VFB as indicated by Register Index. The Register Index value from the input port is relayed to control logic (304), connected to the messenger register file (301). The control logic within the destination VFB continuously relays the state of the presence bit associated with the Register Index value through the local messenger (305) to the to input port. The state of the presence bit is continuously reflected, even in the absence of the assertion of Req, thus is independent of the port selection made by the local messenger (500).

Also referring to the local messenger port (400), Force (415) is driven by the source VFB while Req (410) is asserted to indicate to the destination VFB that a constructive transfer is to be performed even if the access to the messenger register within the destination would otherwise be inhibited due to the presence bit associated with that register being currently asserted. Interrupt (420) is driven by the source VFB while Req is asserted to indicate to the destination VFB that, upon the completion of the constructive access to the messenger register within the destination, the processor within the destination VFB is to be signaled by another means additional to the asserting of the presence bit. An example of this is the assertion of a hardware interrupt line if the processor (303) within the destination VFB were a CPU.

Also referring to the local messenger port (400), Data (430) is a 32 bit data or control value driven by the source VFB and received by the destination VFB. Ack (440) is asserted by the destination VFB to signal the source VFB that the requested transfer has been performed. Whenever Req is not asserted, the destination VFB reacts by causing Ack to be not asserted. Once Req has been asserted by the source VFB, Ack will be asserted by the destination VFB only when the transfer into the destination register file has completed. The source VFB responds to the assertion of Ack by causing Req to be not asserted.

In accordance with this preferred embodiment, each local messenger input port (401) within the destination VFB is continuously provided with the state of the presence bit of the messenger register specified by the Register Index portion of the input port, via local messenger (305) and control logic (304). The state of the presence bit is provided without regard to the state of the Req line. When the presence bit is indicated as not asserted, or its state overridden by the Force input of the local messenger port, and the Req line of the input port is asserted, the local messenger input port asserts a service request to the priority encoder (500) within the local messenger (305).

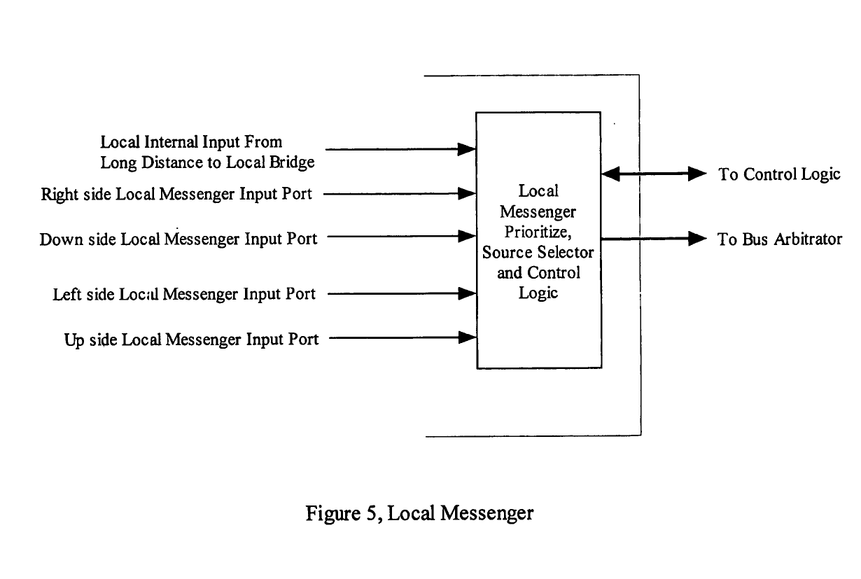

Referring to FIG. 5, the local messenger (305) within the destination VFB contains a five input priority encoder and source selector (500) that chooses one from the five, potentially concurrent, local requests that may arrive into a destination VFB via the local messenger input ports (201, 202, 203, 204 and 310). Four of these request sources are the local messenger input ports driven by the local messenger outputs ports of adjacent VFBs to the right, below, left and up of the destination VFB. The fifth input (310) is fed from a bridge (311) between the long distance messenger (313) and the local messenger system (305). This bridge is described in detail later on in this disclosure. In the current example, the destination VFB receives the local message request from the source VFB right output port (201), into the left local messenger input port (203) of the destination VFB.

In deciding between concurrent local messenger requests arriving at the local messenger input ports of the VFB, the priority encoder (500) within the destination VFB gives preference to the long distance bridge (310), specifically to minimize the delay associated with long distance messages. The priority of selection for the remaining four local messenger input ports is arbitrary.

Once the priority encoder (500) selects a local message input source to process, requests from all other local messenger input sources within the VFB are locked out until the completion of the selected request. The priority encoder (500) then causes the source selector to generate an address referencing the register described by the register index value present on the selected local messenger input port, in the current example the left port (203), and asserts the generated address and the data from the selected input port to the memory bus arbitrator (302) in the form of a constructive access.

The bus arbitrator (302), at the next available opportunity, gains access to the messenger register file (301) and performs the constructive access. Once the access is completed, the source selector (500) signals the completion of the transfer to the currently selected local messenger input port by asserting the Ack line of the input port, and, if the Interrupt input of the selected input port is asserted, also causes an interrupt to be asserted to the processor (303) within the destination VFB.

The local messenger output port of the source VFB (201) in turn responds to the assertion of Ack at the destination VFB port (203) by de-asserting Req. This is in turn detected by the local messenger (305) which causes the control logic (304) of the source VFB to de-assert the presence bits of both the LRIGHTA and LRIGHTW registers.

The operation of each local messenger input port (201, 202, 203 and 204), including the input port provided from the long distance messenger bridge (310), is identical. Further, the above example of a local message sent from a source VFB to the adjacent VFB destination to its right extends to all of the local message directions, with only the port directions and source VFB message registers changing according to the direction desired. Table 4 describes the source VFB registers, source VFB local message output ports, and destination VFB local message input ports used for each potential local message transfer from a source VFB. Thus any two adjacent VFBs may perform the role of source or destination. Further, sufficient resources are present to permit a VFB to be both a source and destination, concurrently, with all of its adjacent VFBs.

TABLE 4
Relationship of Source VFB Local Message Registers to Source VFB
Output Ports and Destination VFB Input Ports

| Source VFB Message | Source VFB Local | Destination VFB Local |
|---|---|---|
| Registers | Messenger Output Port | Messenger Input Port |
| LRIGHTA, LRIGHTW | Right side | Left side |
| LDOWNA, LDOWNW | Down side | Up side |
| LLEFTA, LLEFTW | Left side | Right side |
| LUPA, LUPW | Up side | Down side |

An important attribute of the message handling circuitry is that it is completely combinatorial and not dependant upon any system or local clock. Ergo, the circuitry interrogates, discovers, uses and then releases communications paths at speeds limited only by the intrinsic delays of the physical silicon in which the invention is implemented.

Long Distance Messenger

Referring to FIG. 3 and generally to FIG. 3A, a communications mechanism between non-adjacent VFBs, the long distance messenger (313), is also provided. While it interconnects adjacent VFBs in a manner similar to the local messenger system (305), its function is markedly different in that is it is used to construct the equivalent of a local messenger path between non-adjacent VFBs by using the long distance messenger ports between each VFB as individual segments of a combined path to the desired destination VFB. To do so, it constructs a segmented path through multiple VFBs by using a relative row and column offset address provided by a source, or origin, VFB to establish a connection to the destination VFB.

Referring to FIG. 3, the basic operation of the long distance message transmission is that a source, or origin, VFB performs constructive accesses to its MSENDA and MDATAW registers, with the contents of MSENDA specifying a relative offset to a VFB destination that is not adjacent, and a register within the destination to be modified. The long distance messenger, using the destination VFB offset, then selects a long distance output port in the direction, either horizontal (column) or vertical (row), towards the destination through the array of VFBs and creates a connection to the port. Each output port causes the relative offset fed out of its port to its adjacent VFB to be decreased according to its direction. Thus, as each connection is made through a VFB, the path moves closer to the destination, continuing to decrease the offset as it passes through VFBs until the destination VFB is reached with a zero offset. A final connection is then made to an internal long distance output port that feeds a bridge within the destination. In the preferred embodiment of FIG. 3, the bridge then converts the long distance request into a local messenger request.

In an alternative preferred embodiment illustrated in FIG. 3A, the local messenger ports and local messenger unit have been removed from the configuration for the message passing fabric made in accordance with this embodiment. In FIG. 3A, the message passing fabric method and system remains similar to that of FIG. 3, however because the control logic does not have to consider any local messenger paths, it treats all message send requests as long distance requests. In this preferred embodiment, message transmissions to adjacent VFBs become more variable because the dedicated path of the Local messenger which was used primarily/exclusively for the exchange of data between adjacent VFBs is replaced by a long distance messenger unit which must arbitrate a request originating from the VFB with those passing through it from other sources and paths. Removal of the local messenger ports results in a reduction in the number of connections between adjacent VFBs which is valuable especially in dense designs.

In another alternative embodiment, selectively combining the embodiments of FIG. 3 and FIG. 3A such that some areas of a message passing fabric made in accordance with this embodiment would include a local messenger system and other areas of the fabric would not. In this embodiment any access to direction emanating out of a VFB that has no local messenger connection results in the selection of the long distance messenger system as the transport mechanism.

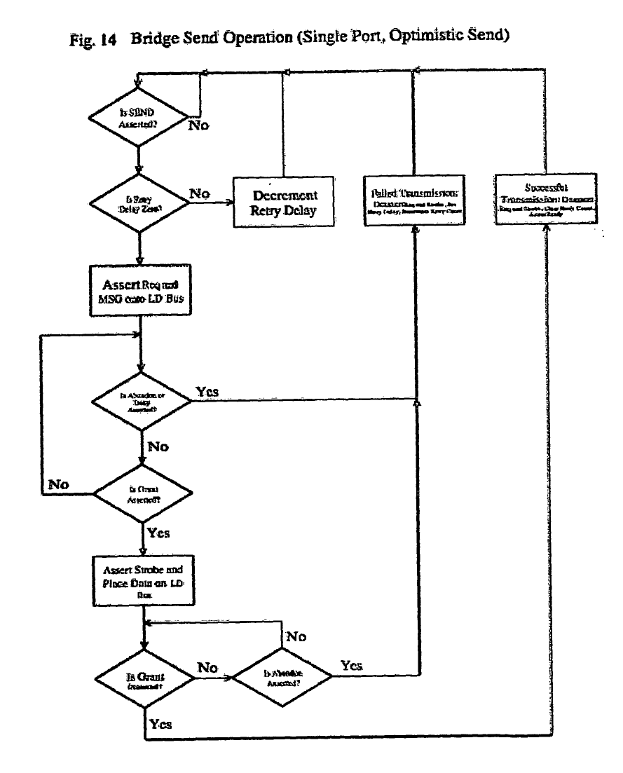

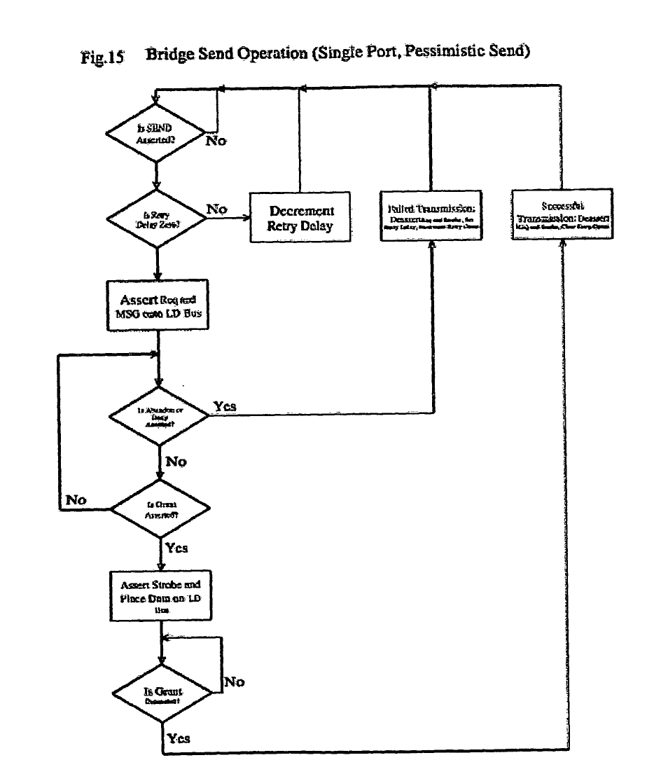

Referring back to the preferred embodiment of FIG. 3, and also the flow charts illustrated in FIGS. 14 and FIG. 15 upon receiving the request, the destination asserts a Grant line back through the established path to the source VFB indicating it is ready to accept the data. The source VFB then feeds the data onto the connection and asserts a strobe line. Upon receiving strobe, the destination VFB causes the data to be placed into the desired messenger register, then causes the Grant line to become not asserted. Once the source VFB receives the non asserted Grant line and has no further data to transfer, it ceases to assert a long distance messenger request. This causes each path connection made between the source VFB and destination VFB to be released.

If, when the initial connection is made to the destination VFB, the register where the data is to be placed is unavailable, an additional line within the connected path, Abandon, is used by the destination VFB to signal the source VFB that it is unable to perform the transfer, and causes the source VFB to abandon the request and release the path. The source will then reattempt the transfer after a delay.

In the process of establishing a path between the source and destination, portions of the desired path may already be consumed by separate connections made between different source and destination pairs. The long distance messenger, upon detecting a blocked path, will choose another port if possible. If no paths exist within the VFB, the long distance messenger asserts a Deny signal to advise the previous VFB in the path that it is unable to forward the connection. The Deny signal causes the previous VFB to select an alternate path in an attempt to circumvent the blockage. Using this mechanism, all minimal-length paths between the source and destination will be attempted until a path is discovered. If no path is available, Deny will be asserted to the source VFB.

Once connected, either a single data value or multiple data values may be sent from the source VFB to the destination VFB, with the Grant signal performing a flow control function for multiple transfers. The source VFB may also elect to construct the path and leave it in a Connected State for an unlimited time, so as it keep a minimum delay connection between it and the destination VFB.

Referring to the preferred embodiment illustrated in FIGS. 2 and 3, each VFB contains four long distance messenger ports (205,206, 207 and 208), each of which is connected to a corresponding long distance messenger port of each of its adjacent VFBs to the right, down, left and up. An additional long distance messenger output port, the long distance messenger internal output (312) is fed to the long distance to local bridge (311), which converts a long distance message request into a local message request that feeds the local messenger internal input port (310). An additional long distance messenger input port; the long distance messenger internal input (314), is fed by control logic (304), and is the means through which a source VFB introduces a message request into the long distance messenger interconnect. The internal input port (314) and internal output port (312) in combination form a fifth long distance messenger port, the internal port (313—also referred to as 600).

Referring to the preferred embodiment illustrated in FIGS. 2A and 3A, each VFB contains four long distance messenger ports (205a, 206a, 207a, and 208a), each of which is connected to a corresponding long distance messenger port of each of its adjacent VFBs to the right, down, left and up. An additional long distance messenger output port, the long distance messenger internal output/or receive port (312a) is fed to the long distance bridge (311a). In accordance with this preferred embodiment, there are two additional long distance messenger input ports/or send ports; the long distance messenger internal input/send ports (314a and 314b), are connected to control logic (304a). In this preferred embodiment one of the long distance messenger internal send ports (314a) is the means through which a source VFB introduces a message request into the long distance messenger interconnect (313a). The internal input port/send ports (314a and 314b) and the internal output/receive port (312a) in combination form a fifth long distance messenger port, the internal port (313—also referred to as 600). The transmission of a long distance message in accordance with this preferred embodiment will be discussed in further detail below.

Referring back to FIGS. 2 and 3, the transmission of a long distance message is initiated by a processor (303) performing a constructive access to the MSENDA register of the messenger register file (301) within the source VFB. The contents of the MSENDA register specify the register index within the destination VFB where the message data is to be placed, and the relative location of the destination VFB from the source destination and additional operational flags described in detail later in this document. Next, the processor (303) in the source VFB performs a constructive access to the MDATAW register of messenger register file (301), providing the data or control information to be transferred to the specified message register in the destination VFB.

The control logic (304) of the source VFB, upon detecting that the presence bits of the MSENDA and MDATAW registers have been asserted as a result of the constructive accesses, indicates the presence of a long distance request to a path optimizer (315). The control logic (304) provides the optimizer with the address information present in the MSENDA register to determine which mechanism, local messenger or long distance messenger, should perform the transfer. If the relative address indicated in MSENDA specifies an adjacent VFB, i.e. the combined row and column offsets indicates a relative row of zero and column ±1, or a relative column of zero and row ±1, then the message request is transferred into the appropriate local messenger registers as indicated in Table 5. This is accomplished by the control logic (304) performing a destructive access to the MSENDA register and transferring its contents via constructive access into the local messenger address register that corresponds to the row/column offset described above. Similarly, the control logic performs a destructive access to the MDATAW register and transfers via constructive access its contents into the local messenger data register for the corresponding direction. This transfer is performed independently of the memory bus arbitrator (302). For any combination of row and column offsets not specifically listed in Table 5, the long distance messenger is utilized.

TABLE 5
Source VFB Row/Column Relative Address Pairs in MSENDA that Result
in Local Messages and the Associated Local Messenger Registers

| | Relative Column | Local Messenger |
|---|---|---|
| Relative Row Address | Address | Registers |
| +1 | 0 | LDOWNA, LDOWNW |
| −1 | 0 | LUPA, LUPW |
| 0 | +1 | LRIGHTA, LRIGHTW |
| 0 | −1 | LLEFTA, LLEFTW |

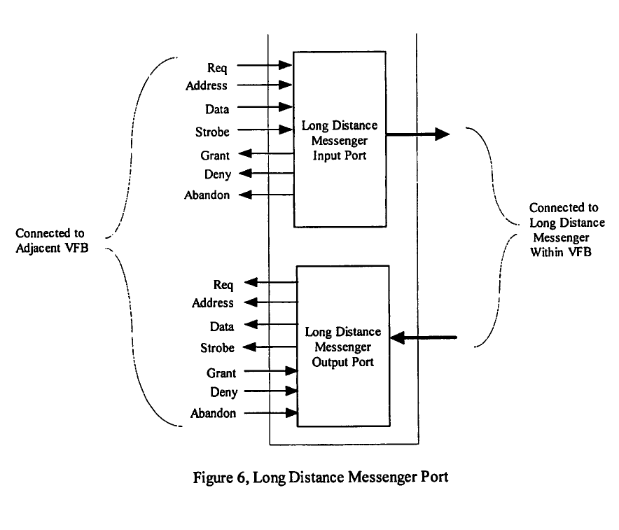

Referring to FIG. 6, and FIGS. 14 and 15, each long distance port (600) consists of an input port (601) and output port (602). Thus messenger port (600) is a more detailed view of each of the long distance messenger ports (205, 206, 207 and 208) and the internal messenger port consisting of the internal input port (314) and internal output port (312). Req, when asserted to an input port, causes the Address, Strobe and Data lines to be acted upon by the input port.

Also referring to FIG. 6, Address is asserted to an input port by an output port, and consists of relative row and column offset expressed in the form of a relative row offset, a relative column offset, a negative row direction bit and a negative column direction bit. All offset values are expressed as the twos complement value of the absolute relative offset. When the row negative bit is asserted, the row direction of message travel is up; when not asserted, the direction is down. When the column negative bit is asserted, the column direction of message travel is left; when not asserted, the direction is right. When exiting through a left or right port, the relative column portion of the address is decreased. When exiting through an up or down port, the relative row portion of the address is decreased. Because the relative row and column offsets are expressed as the twos complement of the absolute offset, decreasing the offset, in this context, is accomplished by adding one to the row or column offset value. Although a two dimensional array is disclosed the use of offset values in multi-dimensional arrays is within the scope of the present invention.

Also referring to FIGS. 6, 14, and 15, Data is asserted to an input port by an output port, and consists of thirty two signal lines that contain control and data information to be passed unchanged through the long distance messenger to a selected output port. Strobe is asserted to an input port by an output port and passes unchanged to a selected output port. Strobe is driven by the source VFB concurrently with valid data to signal the destination VFB of a requested constructive register access into the destination VFB register file.

Grant is asserted to a selected output port by its adjacently connected input port, and passes unchanged through the long distance messenger to the input port selecting the output port. When asserted, it signals the ability of a destination VFB to perform a constructive access to its register file.

Abandon is asserted to a selected output port by its adjacently connected input port, and passes unchanged through the long distance messenger to the input port selecting the output port. It is asserted by the destination VFB to signal the source VFB that the destination is unable to perform the transfer because the presence bit of the desired destination register currently has its presence bit asserted.

Deny is asserted to a selected output port by its adjacently connected input port to signal the lack of availability of a path segment, or group of segments, and is used to cause the selection of an alternative message path if available.

Disconnected State

In the preferred embodiment of FIGS. 2, 3, and 6, the source VFB is considered to be in the disconnected state when the Req line of the long distance messenger internal input (314) is not asserted.

Connecting State

If the optimizer (315) has determined that the VFB address of the message to be sent by the source VFB requires the use of the long distance messenger, the control logic (304) causes the Connecting State to be entered by causing the contents of the source VFB MSENDA register to be placed onto the Data lines of the long distance messenger internal input (314). The control logic (304) also places the row offset, column offset, negative row bit and negative column bit from the MSENDA register contents into the corresponding bit positions of the address portion of the long distance messenger internal input (314). The control logic (304) then asserts the Req line of the long distance messenger internal input.

Long Distance Path Establishment

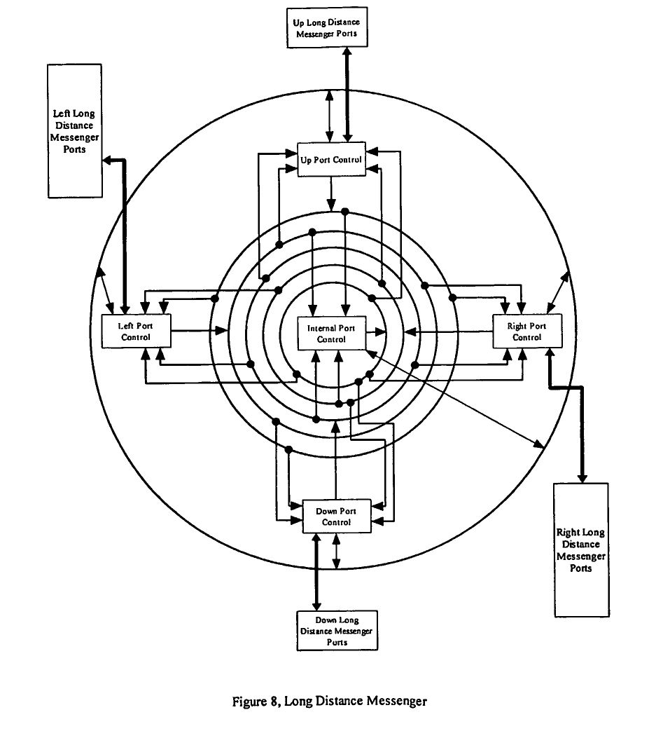

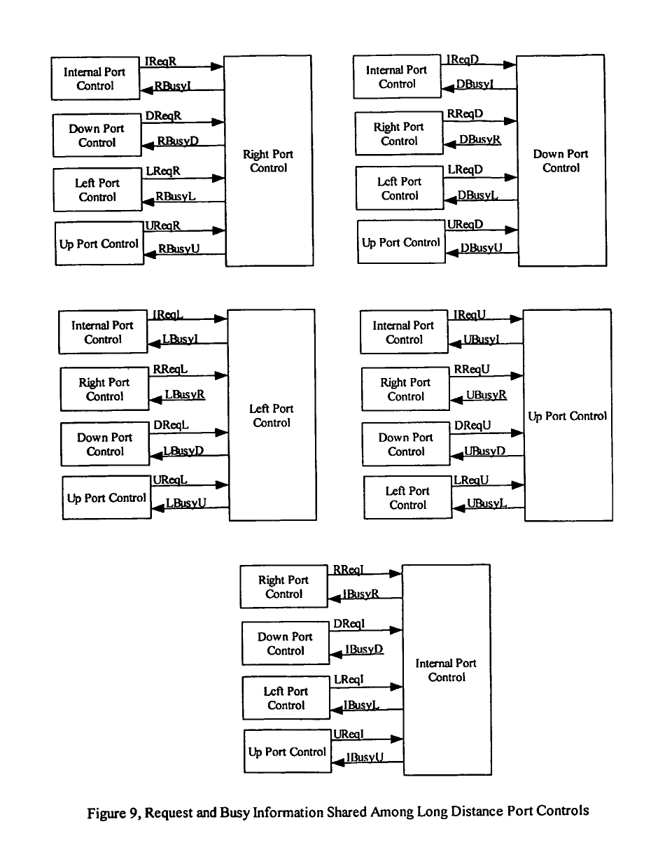

Referring to FIG. 8, each long distance messenger port (205, 206, 207 and 208), and the long distance internal port, has an instance of port control logic (801, 802, 803, 804 and 805) associated with it. Each instance of the port control logic is connected to an associated long distance messenger port, and relays the input port portion of that port to an individual distribution bus (808) to each of the other port controls. Each port control has a selector that is capable of selecting from one of the distribution busses, and passing the information on the bus to the output portion of the messenger port to which it is connected. Thus, within the long distance messenger, any long distance input port may be forwarded to any other long distance output port. A status bus (806) contains request and busy information for each port control so that each port control is able to make a decision based on the desired direction of travel given the ports that are not currently busy. Referring to FIG. 9, each port control has an individual request line and individual busy line for each possible direction. For example, a transfer through the right port control (801), can be requested by the internal port control (805), the down port control (802), the left port control (803) or the up port control (804), and supplies a busy indicator line to each.

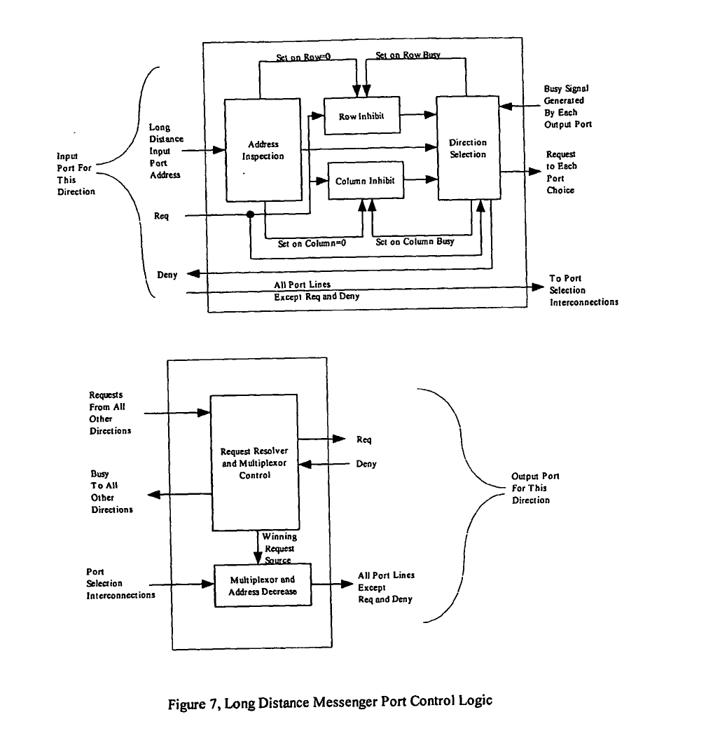

Referring to FIG. 7, a more detailed view of the port logic is shown. The port control logic has two components, input control (603) and output control (604). The input control (603) is connected to a long distance messenger input port (601) for an individual direction, and the output control (604) is connected to a long distance messenger output port (602) for the same direction. The input control is responsible for selecting an output port within the long distance messenger that is capable of moving the message data towards the destination VFB. The output control, based on requests made by the input controls, grants access to an input port by selecting its data from one of the distribution busses (808) and thus relays the selected input port to its output.

Referring to FIG. 7, when Req is not asserted to a long distance messenger input port, the input port control logic (603) forces Grant, Deny and Abandon to be not asserted. The input port control logic maintains latched state information consisting of row inhibit (701) and column inhibit (702) flags that are caused to be not asserted when the Req line of the input port is not asserted. The row inhibit is asserted when it is determined that the up and down output port directions are either in use or of no use given the desired direction of message travel indicated to the port input. The column inhibit is asserted when it is determined that the left or right output port directions are either in use or of no use given the desired direction of message travel indicated to the port input.

When Req is asserted to the input port, the address inspection block (703) inspects the address information present on the input port. If the row offset is zero, the row inhibit (701) of the port control is asserted. If the column offset is zero, the column inhibit (702) of the port control is asserted.

The direction selector (704), based on the address values fed through the address selection block (703), generates one or more potential output port choices according to Table 6.

TABLE 6
Direction Selector: Potential Output Port Choices Based on
Address Values Fed Through the Address Selection Block

| | Row | Column | Column | Potential |
|---|---|---|---|---|
| Row Negative | Address | Negative | Address | Output Port |
| Direction Bit | Offset | Direction Bit | Offset | Choices |
| Don't Care | Zero | Don't Care | Zero | Internal |
| False | Non Zero | Don't Care | Zero | Down |
| True | Non Zero | Don't Care | Zero | Up |
| Don't Care | Zero | False | Non Zero | Right |
| Don't Care | Zero | True | Non Zero | Left |
| False | Non Zero | False | Non Zero | Down, Right |
| False | Non Zero | True | Non Zero | Down, Left |
| True | Non Zero | False | Non Zero | Up, Right |
| True | Non Zero | True | Non Zero | Up, Left |

The potential output port choices are further qualified within the direction selector (704) by combining the potential output port choices with the state of row inhibit (701) and column inhibit (702). Any up or down potential output port choice is disqualified if the row inhibit flag is true. Any right or left potential output port choice is disqualified if the column inhibit flag is true. When neither the row inhibit nor column inhibit flags are asserted, right or left is chosen over up or down, thus yielding a single direction choice.

Referring to FIG. 8, each long distance messenger port input is connected through its control logic providing all of its lines except Req and Deny to all other port controls via distribution busses (808). Five such busses exist, one for each port control. A control bus (806), containing signals from each port control carries control signals between ports as depicted in FIG. 9.

Referring to FIG. 9, each port control, using the control bus (806), is capable of asserting a request indication to any of the other ports. A port to which a request is asserted, using control bus (806), asserts a busy indication to all of the other ports.

Thus, each port control receives four request indications and provides four busy indications.

Referring to FIG. 7, each output port control (604) within the VFB contains a request resolution circuit (750) that provides a busy state of the output port to each of the input port controls within the VFB. When an output port is not is use, it provides a not busy indication to all of the input port controls.

Referring to FIG. 8, an input port control (603), having selected a single direction choice, examines the busy status of the desired output port control (604) for the direction choice, as carried on the control bus (806) to determine if the port may be used. If the output port control for the chosen direction indicates busy, then the row or column inhibit flag of the input port is asserted to cause that direction of travel to be eliminated by the input port as a potential choice. If direction choice is up or down and the desired port is indicating busy, the row inhibit of the input port is asserted. If direction choice is right or left and the desired port is indicating busy, the column inhibit of the input port is asserted.

If the output port in the chosen direction does not indicate busy, then a request is asserted to that output port control (604). Upon receiving the request assertion, the output port control causes a busy indication to be asserted to all input ports controls except the input port asserting the request. This causes all other ports to be prevented from attempting to utilize that port for as long as the request is asserted. The potential exists for a very brief race condition within the request resolution circuit (750). If an output port control is not busy when an input port control has received a message request, and during the period between when the request is asserted to the output port control and the busy is propagating to the other input port controls, an additional message request requiring the same output port control may be received and asserted to the output port control. This results in multiple concurrent requests for the same output direction. The request resolution circuit then indicates, as a result of the multiple concurrent requests, a busy indication to the input port controls for all of the requesting directions, forcing each to select an alternate path.

Once the request resolution circuit (750) of an output port control (604) has resolved the incoming requests and single input port control thereby selected, it then channels the data from the distribution bus (808) driven by the selecting input port control to the output port. The Data lines of the input port are passed unchanged to the output port. The address portion of the input port is passed through to the output port with the row or column offset decreased. For the up or down output port, the row portion of the address is decreased; for the right or left output port, the column portion of the address is decreased. This Address Decrease circuitry is shown as (751) in Error! Reference source not found. Thus, as the message request is moved nearer its destination through a VFB, its address offsets are adjusted appropriately so that upon arriving at the desired destination within the array of VFBs, the address offsets for both row and column are zero. The Strobe line is passed, unchanged, from the input port to the output port. The Grant and Abandon lines are passed, unchanged, from the output port to the input port, and finally, the Req line of the output port is asserted.

The Deny line is not passed directly from the output port to the input port. Instead, when asserted to the output port by the input port of an adjacent VFB, the port control output asserts a busy indication to the selecting input port control. The input port control then forces the row inhibit or column inhibit to be asserted. If the selected output port control is an up or down port, the row inhibit of the input port control is asserted. If the selected output port control is a left or right port, the column inhibit of the input port control is asserted.

In the event that the input port control lacks the availability of any port that would move the message towards its destination, it conveys this inability back to the output port of the adjacent VFB that is connected to the blocked input port by asserting a Deny signal. Deny is generated by the input port control when it detects that both the row inhibit and column inhibit flags are asserted and the row and/or column offset(s) is/are not zero. When Deny is received by an output port, it causes a busy signal to be generated to the input port control that has selected it. This in turn causes the either the row inhibit or column inhibit of the input port control to be asserted, resulting in the dropping of the request for the output port control by the input port control and the generation of a different choice of output port control, or if no choice remains, to generate a deny signal back to the messenger port feeding the input port control. Once connected to the destination VFB, the final input port choice must be the internal output port control. If the internal output port control is asserting a busy state to the selecting input port control, the input port control will assert Abandon rather than Deny to the input port, as there is no alternate path possible.

Thus, once a message request has been asserted to the long distance internal input port (314) of a VFB, the long distance messenger system will exhaustively attempt all potential routes to the destination VFB indicated in the address. Port selections that would result in routes that are circuitous, i.e. would not move a message closer to the destination with each segment constructed, are automatically excluded by the process described. This results in minimum orthogonal length path being constructed between a source and destination VFB through which the source may transmit data and control information to the destination. If a path could not be discovered, the long distance internal input port (314) will receive either a Deny or Abandon signal indicating the attempt was not successful.

Initial Connected State

In the event that a message path is successfully constructed to the destination, the Data lines on the internal output port (312) of the destination VFB—at the time the Req line is asserted on the internal output port—reflect the contents of the MSENDA register of the source VFB that originated the request. The long distance to local messenger bridge (31 1) in the destination VFB then latches the contents of the Data lines, feeding the Register Index, Force and Interrupt portion of the latched information to the local messenger input port (310) connected to the bridge. The source VFB is now in the initial Connected State.

Connected State

After the Initial Connection State has been established, the messenger bridge (311) in the destination bridge monitors the state of the presence bit for the messenger register specified by the register index value present at the input port (310). If the Present line of the input port indicates not asserted or the Force line of the input port is asserted, the messenger bridge logic asserts the Grant line to the internal output port (312), and forces the Deny and Abandon lines of the output port to be forced to a non-asserted state for as long as the Req line of the output continues to be asserted.

During the Connected State, the state of the Grant line on the output port (312) of the destination VFB is then propagated through the established path to the long distance internal input port (314) of the source VFB. When the Grant signal has propagated back to and is sensed by the source VFB, the source VFB is considered to be in the Connected State.

Connected Transfer State

During the Connected State, when the control logic (304) in the source VFB detects the assertion of Grant on the input port (314) and then detects the presence bit associated with the MDATAW register to be asserted, it enters the Connected Transfer State by causing the contents of the MDATAW register within its register file to be placed onto the Data lines of input port (314) of the source VFB, and causing the Strobe line of the port to be driven concurrently.

Next during the Connected Transfer State, the strobe and data present on the Data lines of the input port (314) within the source VFB are propagated through the established path to the output port (312) within the destination VFB. The messenger bridge (311) within the destination VFB, in response to detecting the assertion of the strobe line, transfers the data present on the lines of the output port (312) to the Data lines of the local input port (310) and asserts the Req line of the local input port, effectively generating a local messenger request with the destination VFB.

Next during the Connected Transfer State, the local request is processed by the local messenger (305) within the destination VFB as described previously, resulting in a constructive access to the messenger register (301) indicated by the local request on the input port (310). Upon conclusion of the local request, the Ack line of the local input port (310) is asserted, resulting in the de-assertion of the Req line of the local input port. As a result of this constructive access, the presence bit associated with the accessed register is asserted. This is detected by the messenger bridge (311) causing the Grant line of output port (312) to be de-asserted, and propagated through the established path from the destination VFB to the input port (314) of the source VFB.

Next during the Connected Transfer State, the control logic (304) of the source VFB, detecting the de-assertion of Grant on the input port (314), causes the presence bit associated with the MDATAW register to be de-asserted, and the Strobe line of input port (314) to be de-asserted. Concurrently, if the source VFB control logic (304) detects that the Burst Transfer bit of the MSENDA register is not asserted, the presence bit of the MSENDA register within the source VFB is de-asserted, and the control logic causes the Disconnecting State to be entered, otherwise the Connected State is re-entered.

Disconnecting State

If, at any time during any state other than the Disconnected State the control logic (304) within the source VFB causes the Req line of input port (314) to be de-asserted, the Disconnecting State is entered. During the Disconnecting State, each VFB that constitutes the path constructed between the source VFB and destination VFB passes forward the de-assertion of Req from the source VFB towards the destination VFB. The de-assertion of Req is passed along any VFB through which a path (either completed or partial) was established. When Req is de-asserted on the input port (314), its request for a corresponding output port (205, 206, 207 or 208) is de-asserted, causing the output port in turn to de-assert Req to its output port. Thus the destruction of the path occurs from source VFB to destination VFB as a result of the Req line of the input port (314) of the source VFB being de-asserted, and resulting in the Disconnected State being entered. The control logic (304) will de-assert the Req line to the input port (314) when it detects the presence bit associated with the MSENDA register to be no longer asserted.

Burst Transfers

After the first Connected Transfer State, if the Burst Transfer bit of the MSENDA register within the source VFB is asserted, the source processor (303) may continue to transfer data and control information to the destination VFB by performing repetitive constructive accesses to the MDATAW register. Each constructive access to the MDATAW register of the source VFB will cause a Connected Transfer State to be entered when the control logic (304) of the source VFB detects the assertion of the Grant line on the internal input (314). The source and destination VFB will remain in a Connected State until the processor (303) within the source VFB causes a destructive access to the MSENDA register.

Abandoned State

If, after entering the Initial Connected State, but before entering the Connected State, the messenger bridge (31 1) in the destination VFB when monitoring the state of the presence bit for the messenger register specified by the register index value present at the input port (310) determines the present bit of the input port is asserted and the Force bit of the internal output port (312) is not asserted, the messenger bridge logic asserts the Abandon line to the internal output port (312), and forces the Deny and Grant lines of the output port (312) to be forced to a non-asserted state for as long as the Req line of the output continues to be asserted.

During this abandoned state, the Abandon signal is propagated from the output port (312) of the destination VFB, to the input port (314) of the source VFB. Control logic (304) within the source VFB then causes the retry state to be entered.

Retry State

The Retry State causes the Disconnecting State, Disconnected State and, potentially, a Connecting State to be entered by forcing the Req line of the long distance messenger internal input (314) to be de-asserted by control logic (304) within the source VFB for an arbitrary delay period. This delay period is 8.33 nanoseconds in the preferred embodiment.

Deny State

If, during the Connecting State, but before entering the Connected State, the source VFB control logic (304) detects the assertion of the Deny signal on the input port (314), the Retry State is entered.

Overall Operation, Single Transfer, Without Path Contention

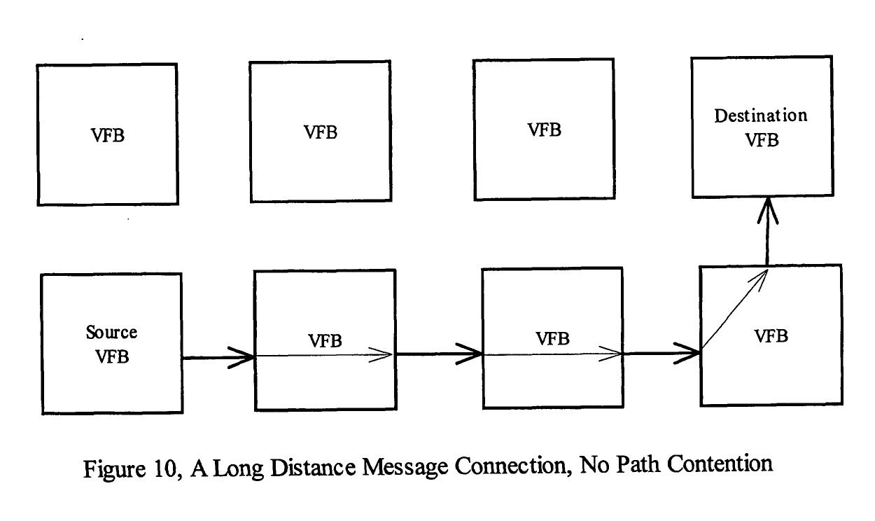

To further clarify the general operation, referring to FIG. 10, the overall operation of sending a message from a Source VFB (1001) to general purpose messenger register M1 (register index 9 hex, see table 1) of the register file of the destination VFB (1002) consists of the following sequence. Row and column offset addresses include the state of the negative row and negative column bits, thus are summarized as {Row Offset, Column Offset) for this operational description.

First, the processor (303) of source VFB (1001) performs a constructive access to the MSENDA register of its messenger register file (301), with a value if 00010389 hex, indicating that register M1 of the VFB located 3 columns to the right, and 1 row above is to be modified {−1,3}. Next, processor (303) of source VFB (1001) performs a constructive access to the MDATAW register of its messenger register file (301), with an arbitrary value to be placed into the Ml register of the messenger register file (301) within the destination VFB (1002).

Next, the control logic (304) within the source VFB in conjunction with the optimizer (315) determines, based on the row and column offset addresses present in the source VFB MSENDA register, that long distance messenger is required to transfer to the data to the destination VFB (1002), and enters a Connecting State as described previously.

Next, the long distance messenger within the source VFB (1001) selects the right side output path—its preferred direction—and asserts a long distance request to the VFB to the right (1003). The right side long distance output of VFB (1001) is presenting row and column offset values of {−1, 2} to the left side input of VFB (1003).

Next, the long distance messenger of VFB (1003), selects the right side output path—its preferred direction—and asserts a long distance request to the VFB to its right (1004). The right side long distance output of VFB (1003) is now presenting row and column offset values of {−1, 1 } to the left side input of VFB (1004).

Next, the long distance messenger of VFB (1004), selects the right side output path—its preferred direction—and asserts a long distance request to the VFB to its right (1005) The right side long distance output of VFB (1004) is now presenting row and column offset values of {−1, 0} to the left side input of VFB (1005).

Next, the long distance messenger of VFB (1005), having its column inhibit flag asserted due to the zero column offset it is receiving from VFB (1004), selects the alternate direction, the up side output path, and asserts a long distance request to the destination VFB above (1002). The up side long distance output of VFB (1005) is now presenting row and column offset values of {0, 0} to the down side input of VFB (1002).

The long distance messenger of destination VFB (1002), recognizing the row and column address as {0, 0} received on its down side port, asserts a long distance request to its internal long distance messenger output port. The control logic of the destination VFB (1002), in turn feeding its long distance to local messenger bridge (3 1 1), in turn feeding the local messenger internal input port (3 10), achieves an Initial Connection State.

The messenger bridge of the destination VFB (311)—in conjunction with internal input port (310) and control logic (304)—examines the presence bit of the MI register index described in the request. It determines that the transfer is not inhibited, thus enters a Connected State by asserting Grant to the internal input (314).

The source VFB (1001), reacting to the Grant assertion passed back from the destination VFB to the source VFB, enters a Transfer State that transfers the contents of the source VFB (1001) MDATAW register to the M1 register of the destination VFB (1002). Following the Transfer State, the source VFB (1001) returns to the Connected State, and, as indicated by a non-asserted Burst mode bit within its MSENDA register, enters a Disconnecting State followed by a disconnected state.

Upon conclusion of the message transfer, the source VFB (1001) has the presence bits associated with its MSENDA and MDATAW messenger registers not asserted, and the destination VFB (1002) has the presence bit associated with its Ml messenger register asserted and the M1 register contains the contents of the source VFB MDATAW register at the time of the Transfer State.

Overall Operation, Burst Transfer, Without Path Contention

Also referring to FIG. 10, and using the same example as in Overall Operation, Single Transfer, Without Path Contention described above, but with the Burst mode bit asserted within the MSENDA register of the Source VFB (1001), the source may transfer multiple values to the destination VFB (1002).

After the first Transfer State has been performed and the source VFB has returned to the Connected State, the Disconnecting State is not entered. Instead, the source VFB (1001) remains in the Connected State. As a result of the initial Transfer State, the Grant line presented to the source VFB through the established path is now de-asserted, reflecting the assertion of the presence bit of the MI messenger register of the destination due to the presence of data in that register.

The processor of the source VFB (1001) then performs additional constructive accesses to its MDATAW register, while the processor of the destination VFB (1002) performs destructive accesses to its MI register, thus consuming the values transferred to it by the source VFB, until the number of values desired by the source VFB has been transferred. The source VFB (1001) then terminates the connection by performing a destructive access to its MSENDA register or causing the presence bit associated with its MSENDA register to be not asserted via the MSTATUS register.

During the process, each Transfer State is conditioned upon a value being present in the source VFB MDATAW register and a value not being present in the MI register of the destination VFB (1002), as indicated by the state of the presence bits associated with each.

A constructive access by the processor of the source VFB (1001) to its MDATAW register when a Transfer State has not yet transferred the previous value results in the processor of the source VFB being forced to wait until the Transfer State is performed. Likewise, a passive or destructive access by the processor of the destination VFB (1002) to its M1 register prior to receiving a value through a Transfer State results in the processor of the destination VFB being forced to wait until the Transfer State is performed. Thus the source and destination processors operate in a synchronized manner through the established path.

Overall Operation, Retry of Communication

Also referring to FIG. 10, and using the same example as in Overall Operation, Single Transfer, Without Path Contention described above, repeated attempts to transfer a value to the destination VFB (1001) will be performed if the messenger register within the destination VFB (1002) has its associated presence bit asserted at the time the Initial Connection State is reached.

After the source VFB (1001) has attained the Initial Connection State, if the presence bit associated with the messenger register within the destination VFB (1002) is asserted, the destination VFB will assert Abandon to the source VFB causing the source to enter the retry state. Consequently the path established is broken down then reestablished after the retry delay until a Transfer State is achieved.

Overall Operation, With Path Contention

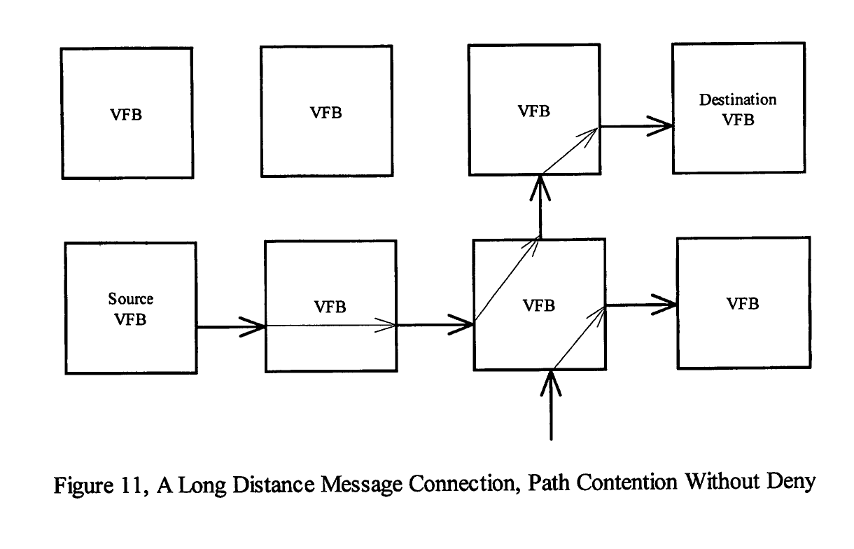

Referring to FIG. 11, and using the same example as in Overall Operation, Single Transfer, Without Path Contention described above, a portion of the path that would be utilized in the absence of contention is automatically circumvented. Presuming that a portion of an unrelated path has been established that consumes the long distance message path arriving at the down port of VFB (1004) feeding into the left port of VFB (1005), the operation varies as follows.

During the connecting state, the long distance messenger of VFB (1004), as a result of a busy asserted by the right side output path, will then select its alternate direction, up, and assert a long distance request to the VFB above (1006), with a decreased row address, now at zero, {0, 1}.

Next, the long distance messenger of VFB (1006), selects the right side output path—its preferred direction—and asserts a long distance request to the destination VFB (1002), with a decreased column address, now at zero {0, 0}.

Thus an alternate path to the destination VFB was discovered in the presence of contention for a portion of the path between a source and destination.

Overall Operation, With Path Contention Resulting in Deny

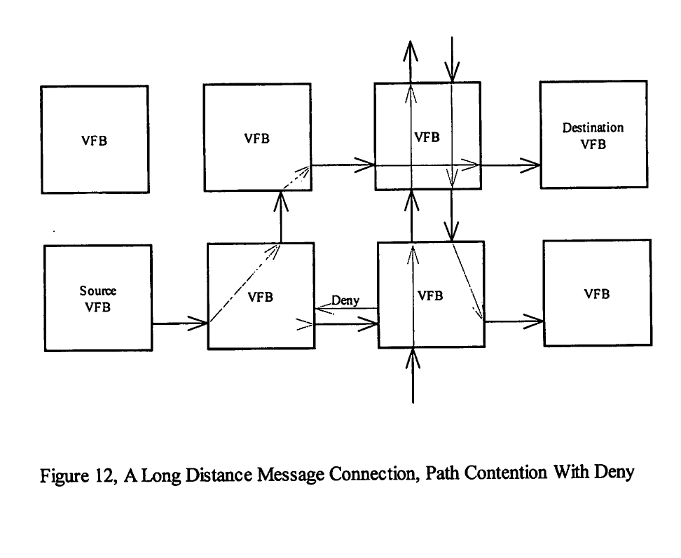

Referring to FIG. 12, and using the same example as in Overall Operation, Single Transfer, Without Path Contention described above, a portion of the path that would be utilized in the absence of contention is circumvented. Presuming that unrelated paths have been established that consume the long distance message path passing into the up port of VFB (1006) into the left port of VFB (1005), and passing into the down port of VFB (1004) and out of the up port of VFB (1006), the operation varies as follows.

During the connecting state, the long distance messenger of VFB (1004), as a result of a busy asserted by the right side output path, will then select its alternate direction, up. As a result of a busy asserted by the up side output path, there is no selection remaining that moves the path closer to the destination VFB (1002). VFB (1004), having no suitable direction choice available, asserts a Deny to its path predecessor, VFB (1003).

As a result of the Deny signal from VFB (1004), VFB (1003) causes the column inhibit for its left port to be asserted and the alternate path choice, up, to be selected. This succeeds, causing the selection of the up side output port of VFB (1003) to assert a long distance request to VFB (1007), with a decreased row address, now at zero, {0, 2}.

Next, the long distance messenger of VFB (1007), selects the right side output path and asserts a long distance request to VFB (1006), with a decreased column address, {0, 1}.

Next, the long distance messenger of VFB (1006), selects the right side output path and asserts a long distance request to the destination VFB (1002), with a decreased column address, {0, 0}.

Thus an alternate path to the destination VFB was discovered in the presence of contention for a portion of the path that required a portion of the route being established to be undone and an alternate path discovered in it place.

Peripheral Array Connections

Referring to FIG. 1, the periphery of the array requires a stub (103) or input/output connection (104) to correctly terminate the local and Ion, distance messenger connections.

A stub (103) requires no additional logic, but connects all of the local messenger input lines feeding into the VFB to a de-asserted state.

In addition, the stub connects all of the long distance messenger input lines to a de-asserted state with the exception of the Abandon and Grant lines of the output port, which should both be tied directly to the Req line of the output port. This will cause a unique state to be signaled to a source VFB, specifically the simultaneous occurrence of both Grant and Abandon during the Connecting State that the source VFB may use to detect a long distance message request to non-existent VFB.

A input/output connection (104) is used to transfer data into or out of the processing array (100), and may consist of all or any of the local messenger input port, local messenger output port, long distance messenger input port, or long distance messenger output port connected adjacently to the VFB to be accessible via external pins or other connection means to arbitrary external circuits. Any port not utilized must be terminated as described for the stub function (103).

Alternate Embodiments

Several potential alternate embodiments of the current invention will be discussed here to insure coverage under this disclosure.

Referring now to the preferred embodiments illustrated in FIGS. 2A and 3A, An alternative embodiment that is more compact and requires less physical connections between the VFBs is readily facilitated by removing the local messenger system entirely from the invention. When this is done, the method by which the processing elements within the VFB sends a message remains unchanged, as the control logic, devoid of any local messenger paths to consider, needs simply to treat all message send requests as long distance requests. Although theoretically, this preferred embodiment can reduce the performance potential of a collection of VFBs passing and exchanging data that are located adjacently, as in the case for some pipelined or systolic implementations of an algorithm, because the combinatorial complexity of local message transmission is less than that of long distance message, the reduction is not significant compared to the reduction in the number of connections between adjacent VFBs. In addition, as stated previously, in accordance with this system and method, message transmission to adjacent VFBs becomes more variable because the dedicated path of the removed local messenger ports which was, used exclusively for the exchange of data between adjacent VFBs is now functionally replaced by the long distance messenger, which must now arbitrate a request originating from the VFB with those passing through it from other VFB sources and message paths. A system and method of message passing fabric constructed according to this preferred embodiment typically results in a % reduction in the number of connections between adjacent VFBs. This reduction results in up to a 60% reduction in the number of connections between adjacent VFBs; preferably the reduction results in 20% to 60% reduction; more preferably, the reduction results in up to a 50% reduction in the number of connections between adjacent VFBs. A reduction in connections between adjacent VFBs becomes more valuable as the density of the design increases.

Also, another alternative embodiment to that Illustrated in FIGS. 1 through 3, which was mentioned above is to provide a system and method of message passing fabric that is a hybrid design of the selective combination of the embodiments illustrated in FIGS. 2, 2A, 3, and 3A, resulting in some areas of the message passing fabric with a local messenger system and others without. In accordance with this preferred embodiment, any access to direction emanating out of a VFB that has no local messenger connection results in the selection of the long distance messenger as selected message passing transport mechanism.

An another alternative embodiment of the present invention, a distributed memory architecture is converted to one that facilitates a distributed shared memory which is both written and read by the VFBs ubiquitously, through memory addressing. This embodiment addresses handling processing problems where data is primarily used locally within a VFB, but must also be made available to other VFBs throughout the mesh of the message passing fabric. While the function of this embodiment could be performed in software, typically, the overhead involved would negatively impact the performance of the system and result in greatly decreased processing performance and throughput, particularly for smaller exchanges where the software overhead far exceeds the amount of data transferred. Therefore, when a means of performing this preferred embodiment is provided that permits transparent shared access by simple memory addressing, it effectively virtualizes the existence and read/write access of each VFBs memory and messenger register system within each VFB.

In accordance with this embodiment, within each VFB, its own memory system and the memory systems of each other VFBs is represented as a section of the address space of the VFB. This system and method message passing fabric permits seamless access throughout the mesh of the fabric, without the aid of software. By way of example, if the combined size of the local memory and messenger registers within a VFB consumes 64 Kbytes (16 bits of addressing information) in total, and a 32 bit address is utilized for the bus arbiter mechanism, then the remaining 16 bits of address information may be used to transparently reference other VFBs throughout the mesh by using those bits as a VFB address. In this example, 16 bits of VFB address are afforded allowing a large number of VFBs to be transparently addressed within a single mesh.

In a message passing fabric made in accordance with this preferred embodiment, the fabric is flexible with regards to the placements of functions within the fabric mesh. Since access to other VFBs is now attained via a simple memory access, the software is easily written in a way that permits relocation of the function within the mesh. This is because the representation of a the location of a section of VFB memory is universal—the same VFB is represented as the same address space in each other VFBs total address space, allowing pointers to any location within the total distributed memory to be readily generated, exchanged and modified amongst the message passing fabric mesh of VFBs.

In order to provide the method and systems of this preferred embodiment, a means of bidirectional access must be provided that permits a VFB to not only write the messenger registers of another VFB, but also write to its own memory as well. Further, the means must permit the memory and messenger registers of another VFB to read. To be transparent to the software, both of these functions must respect the operation of the presence bits associated with the messenger register. Otherwise the software would need to be written to differentiate between local accesses within the VFB and accesses to other VFBs.

In accordance with this preferred embodiment, the message for-mat must be altered to accommodate the following information: the VFB address of the sender, (or origin), of the request, the address within the VFB peers address space of the data to be accessed, a read/write indicator and the width (8, 16, 32 bits, etc.) of the access.

The Locator register, contained within the messenger register file of each VFB, is modified to contain both the address of the Locator function and the absolute address of the VFB within the fabric mesh expressed in terms of row and column. It is filled at system startup programmatically or may be hardwired as a fixed address, or dynamically programmed. Implementation of this embodiment can be extended to multi-dimensional arrays.

The bus arbiter within each VFB, which normally accepts a memory access request from the processing element within the VFB and passes it to the local memory system of the VFB, is modified to consult the Locator register within the VFBs messenger register file to determine the address of the VFB being referenced by comparing the upper 16 bits of the local address referenced to the row and column contained within the Locator register. If the VFB address portion of the memory access refers to a VFB address of zero row and zero column, or the VFB address portion refers to the VFB address of the processing element originating the memory access, the bus arbiter treats the request as local and passes the memory access directly to the local memory system for execution.

In accordance with this preferred embodiment, if the memory address is found not to be local, or addressed to itself, as described above, the bus arbiter constructs a long distance request containing the address of the destination VFB, the type of access (read/write), the width of access (8, 16, 32 bits, etc.) and the offset within the destination VFBs local address space (i.e. the lowest 16 bits of the memory address). For a write request, the bus arbiter changes the addresses presented to the local memory system to that of the MDATAW register and performs a constructive access to MSENDA with the constructed message and to MDATAW with the data the processing element that is attempting to write in to memory. The action of the presence bits, associated with messenger registers as described in the other embodiments applies to this access, therefore the register will not be overwritten unless the presence bits associated with MSENDA and MDATAW are not asserted. Upon performing this transfer into messenger registers MSENDA and MDATAW, the processing element is free to resume its processing, and the message transfer is performed as described in the other embodiments, but with a modified control logic operation in the destination VFB receiving the message.

The control logic operation differs in that the expanded address and access type information provided as a result of the modified message format of received messages is sufficient to not only address a location within the messenger register file of the destination, but also sufficient to address any local memory location within the destination. Thus the ability to write to any location within the local memory system of any VFB within the mesh is facilitated.

Similarly, for a read request generated by the processing element that is not to a local address, the bus arbiter changes the addresses presented to the local memory system to be that of the MDATAR register and performs a destructive access to the MDATAR register, and concurrently performs a constructive accesses to MSENDA with the constructed read message and to MDATAW with zero data. The action of the presence bits, associated with messenger registers as described in the other embodiments applies to this access, therefore the register will not be overwritten unless the presence bits associated with MSENDA and MDATAW are not asserted. Likewise, the presence bit of the MDATAR register will not currently have its presence bit asserted, thus the processing element will be forced to wait until the presence bit of MDATAR is asserted. Upon performing this transfer into messenger registers MSENDA and MDATAW, the processing element is thus held in wait until a message received via the message passing fabric system results in the a constructive access to the MDATAR register. As with the write message send described above, the read progresses similarly except the data transferred along with the message is zero and has no significant value. The transmission of the data value during the message send may be suppressed as a design variant.

The control logic operation in the message destination differs in that the expanded address and access type information provided as a result of the modified message format of received messages is sufficient to not only address a location within the messenger register file of the destination, but also sufficient to address any local memory location within the destination. In addition, the modified message format provides a read indication which the control logic uses to present a read request to the bus arbiter. The result of the read operation in the destination is placed into the MDATAW register of the destination and concurrently a reply message to the read requestor is formed. The reply message specifies the requestor contained in the received read message as the destination, a write operation, the same access width as indicated in the received message, and a local address offset (the lowest 16 bits) that specifies the MDATAR register of the source. The reply message is placed into the MSENDA register of the destination VFB via a constructive access. This results in the data read being transmitted via the message passing fabric system to the MDATAR register of the source of the read request, thereby, the source of the read request, now having the presence bit of its MDATAR register asserted. Thus the ability to read to any location within the local memory system of any VFB within the mesh of the message passing fabric is facilitated.

If the MSENDA or MDATAW register of the destination VFB has its presence bit asserted at the time the read message arrives, a message send is already in progress causing the destination to be unable to reply to the read request. Consequently, the read request should be rejected by the assertion of abandon to the source of the request. The source will reattempt the message as described in the preferred embodiments until successful.

In a preferred embodiment of the present invention, a method and system to prevent a problem known as deadlock is disclosed. An example of deadlock is presented for explanation purposes. Depending on the functional relationship between the processes running in A, B and C, a deadlock may occur if A is expecting C to destructively read the contents of the same register in A that B is attempting to write, and C requires the contents of a memory location in B prior to performing the destructive access to A. B cannot continue until A is read by C, C cannot continue until B responds to its read request, and A cannot permit B to constructively access it until C performs the destructive access. Thus a deadlock occurs.

In the above preferred embodiments, a potential performance limitation, (or deadlock) may occur. Consider the interaction of three VFBs A at (1,1), B at (2,2) and C at (3,3) within the mesh. If B is currently in the process of sending a message to A which is repeatedly rejected by A, and C generates a read request to B, B will be unable to satisfy the read reply to C because its MSENDA and MDATAW registers are in use attempting to send the message to A. Consequently, C is forced to wait until B is finally successful in transmitting its message to A.

This type of deadlock and the example set forth above may be remedied by this preferred embodiment, by providing an additional message send port for use exclusively by message read replies. It does not require an additional set of messenger lines, and may be very simply accommodated by providing a multiplexer within the control logic that selects a message source, either a normal message send or ready reply and alternates attempts to satisfy each. When ready replies are then formed as a result of a read request, the reply is then placed into the read reply port rather than using MSENDA and MDATAW which constitute the normal message send port. An example of this preferred embodiment is illustrated in FIG. 3A where the additional message send port (314b) is used exclusively by message read replies.

An additional enhancement to the preferred embodiments is to provide a means of protection to prevent unwanted, accidental or malicious accesses to a VFB within the mesh of the message passing fabric. In larger arrays of VFBs, one or more threads of execution, each utilizing independent collections of VFBs is anticipated, thus means to isolate the activity of these threads of execution from each other become not only useful, but recommended to aid in creating more stable and reliable systems in practice.

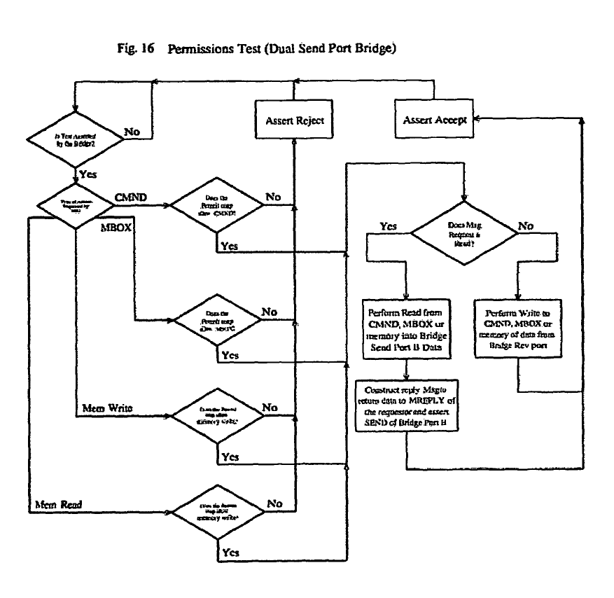

Protection may be afforded by maintaining a RAM based lookup table within each VFB, contained within the control logic and referred to as a permissions map that controls the right to access a particular aspect or area of the memory and/or messenger registers of a VFB by another VFB. FIG. 16 illustrates a flow chart in accordance with a permissions test in the embodiment set for in FIG. 2A and 3A. This flow chart is presented as an example of permissions test, it is not intended to limit the use of a permissions map to the embodiment set forth; the permissions map is applicable to the other alternative embodiments of the present invention.

The permissions map uses the VFB address of the source of a received message as an index into the permissions map to yield a set of restrictions for the source of the message, which is supplied as a part of each transmitted message. An entry in the permission map may include permissions including, but not limited to, the right to write to messenger registers, read from messenger register, write to memory and read from memory, with additional rights limited only by the width of permissions map entry.

When a VFB receives an incoming message, as described in the preferred embodiment or one of the alternative embodiments, the type of access and location with the VFBs address or messenger register space may be tested against the rights afforded by the permissions map. Received messages that have insufficient rights according the permissions map may be accepted but ignored or result in a rejection via the assertion of abandon through the messenger system.

The permissions map may be populated by allocating the use of one of the messenger registers, referred to as the PERMIT register, as means of storing a permission value. The permission value must specify the VFB to which it applies and the rights that are to be afforded the VFB. Once a permissions value has been placed into the PERMIT register via a constructive access, the control logic then uses the VFB address contained within the permission value to index the permissions map RAM and places the rights portion of the permissions value at that location. Thus for each VFB an independent table controlling the rights afforded to other VFBs is created. Subsequently, each time a message is received, the permissions map is consulted by the control logic, using the address of the sender of the message as an index, to yield the rights that the receiving VFB has granted to the sender of the message so that a decision such as but not limited to perform, ignore or reject the message may be made.

An additional preferred embodiment to enhance the message passing fabric route establishment mechanism is to permit a limited number of non-optimal path segments to be utilized to facilitate routing around blocked message path segments. For purposes of this disclosure this is referred to as the time to live. This is readily facilitated by the addition of an additional INDIRECTION LIMIT field transmitted with the addressing information that specifies the maximum number of non-optimal path segments that are permitted to be used in the construction of the path. Normally, the path chosen is completely optimal and minimal length, meaning that no path segment is used that directs the path away from the intended destination. However, it is possible that existing established path segments unrelated to the path being generated can create barriers or blockages by consuming path segments that must be utilized in the construction of an optimal path. To accommodate this, an arbitrary INDIRECTION LIMIT value is emitted with the addressing information from the source VFB. If a node within the messaging fabric, while involved in the construction of a path, has exhausted the preferred route paths, it may chose from the remaining directions that does not point backwards towards the previous path segment if the INDIRECTION LIMIT value is non zero. Each time a non-preferred direction is selected in this way, the decremented INDIRECTION LIMIT is passed from the selected, non-preferred port. Thus INDIRECTION LIMIT contains the extent to which non-optimal path segments may be utilized to achieve the construction of a path around barriers.

In yet another additional preferred embodiment to enhance the message passing fabric is to provide a higher layer of message processing fabric that ties clusters of message processing fabric together. This higher layer of messaging fabric is connected such that one path segment of the second message fabric layer represents the equivalent of a N path segments within the lower messaging layer, allowing messages to traverse longer distances while utilizing a lower number of path segments. To be eligible for a transition of the message path into the higher layer of messaging, the relative path displacement remaining, for either mesh direction must equal or exceed the dimensions of the cluster for the direction to be traversed. The higher messaging layer, then decrements the relative path offset that remains to the constructed by the number of lower layer messaging path segments traversed by the traversal of a single messaging path segment of the higher layer. The resistance of at the lower layer messenger fabric to transition into a higher messaging layer may be controlled by use of the INDIRECTION LIMIT mechanism above. Where the traversal into the high layer has a cost, and is greater than the INDIRECTION LIMIT, the traversal to the upper layer is declined, otherwise the traversal is made and the INDIRECTION LIMIT reduced by the cost. This will help to more fully utilize lower messaging layer prior to the consumption of paths through the higher layer messenger fabric, by discouraging the use of the higher layer until a fairly thorough attempt to exhaust available routes in the lower layers has been made.

The nomenclature, polarity, bus-widths, bit and word positions, and signaling levels as described in this disclosure are representative only and should not be viewed as limiting. In addition, while defined herein as electrical in nature, other means for implementing the current invention such as optical, mechanical, and chemical systems are to be considered as within the scope of the present invention.

The functionality, nomenclature, and number of Processing Elements (referred to herein as Virtual Function Blocks or VFBs) to communicate via the present invention are outside of the scope of this disclosure; it is the means and apparatus used for dynamically discovering and creating/relinquishing these communications channels that is the focus of this disclosure. Similarly, while the description of the preferred embodiment describes an exemplary array of homogeneous processing elements, the current invention can be equally employed to connect heterogeneous elements. To be used in a system connected by the current invention an element need only the ability to access the messenger register file. Further, the array of elements need not share; any combination of rows and columns can be accommodated simply by adjusting the usable range of bits allowed in the absolute Row Offset and Column Offset fields of the MSENDA register of the messenger register file. A maximum of a 512 by 512 VFB array is supported by the description in the preferred embodiment (eight bits defining absolute offset and one bit defining the direction for each of the two generalized dimensions). Larger arrays could be accommodated by extending the absolute offset bit fields.

The preferred embodiments provided herein describe a message passing fabric in modular processor architecture where the fabric asynchronously establishes routes through use of the various preferred embodiments for synchronous messages from an origin or source processing element, VFB to a destination processing clement, VFB thereby causing an operation to occur at the destination processing element, VFB. The preferred embodiments provided herein describe system and method of the invention in terms of a single, integrated circuit, realized in a single piece of silicon. An important benefit of the present invention is that functions connected by the invention only need to incorporate the described interface and control circuitry to allow seamless operation and communication within an array of functions with like interface and control circuitry. Therefore, the concepts and operation of the current invention can be extended to individual blocks or “tiles”, placed together in an array such as in a multi-chip module (MCM) or even through separate, individually packaged devices connected externally, for example on a printed circuit board. No external interface or glue logic is required to connect such blocks; they simply need to be placed next to each other and wired together. All such physical embodiments are to be considered as within the scope of this disclosure.

Alternate hardware and/or software-based retry scenarios are possible and should be considered within the scope of this disclosure. Specifically, random, increasing delay, decreasing delay, and/or any combination of these retry scenarios are within the scope of this disclosure.

The interconnect mechanism disclosed herein for an exemplary two-dimensional array of VFBs can be extended to three or more dimensions. For each additional dimension, the interconnect and control structures—including extensions to the messenger register file and the arbitration/selection circuitry—would be replicated. For example, a three-dimensional array would add “above/below” to the “left/right” and “up/down” generalized dimensions of the current invention. Local message registers for data and address would be added in the messenger register file to support the ABOVE and BELOW directions, and the presence bits of such registers reflected in the MPRES and MSTATUS registers. The MSENDA register in messenger register file would require additional bit fields for describing the above/below absolute offset and direction. The local and long distance input and output message ports, plus the control logic driving these ports, would also be replicated in each VFB. The local messenger prioritizer, source selector, and control logic would have two additional sets of inputs, one from the “above” and one from the “below” local message ports. Request resolver, multiplexer control, multiplexer, and address decrease circuitry would be incorporated in each VFB for each new port (above and below, in this instance) and an additional distribution bus for each additional port would be connected to the port control logic of all other ports (including the internal port control). An inhibit flag—similar to the row and column inhibits of the current invention—would be required for the new dimension, and the Direction Selection circuitry would be modified to include the new dimension in the decision process. The concept can be extended to four or more dimensions by adding the necessary circuitry and interconnect for each new dimension.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the preferred embodiment described herein is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. Those having skill in the relevant arts of the invention will now perceive various modification and additions which may be made as a result of the disclosure herein of the preferred embodiment. Accordingly, all such modification and additions are deemed to be within the scope of the invention, which is to limited only by the appended claims and their equivalents.

What is claimed is:

1. A message passing fabric modular processor system comprising:
a plurality of processing elements, each element accessing a set of available processing elements;
a plurality of message ports in communication with each processing element, each pair of message ports on adjacent processing elements defining a message path therebetween;
addressing means associated with each processing element for indicating the destination of a message in the fabric;
prioritization means associated with each processing element and each message port for determining which message port is to be given access to the associated processing element or message port;
wherein the fabric asynchronously establishes routes for synchronous messages from an origin processing element to a destination processing element to permit an operation to occur at the destination processing element.

2. The message passing fabric modular processor system of claim 1 wherein the processing elements are selected from the set of central processing units, arithmetic logic units, memory elements, arbitrary function generators, state machines, digital signal processors, analog signal processors, programmable logic devices, field programmable gate arrays, complex programmable logic devices, input elements, output elements, and general purpose logic elements.

3. The message passing fabric modular processor system of claim 2 wherein the fabric is comprised of heterogeneous processing elements.

4. The message passing fabric modular processor system of claim 2 wherein the fabric is comprised of multiple sets of heterogeneous processing elements.

5. The message passing fabric modular processor system of claim 4 wherein the type of processing elements is selected based upon the computational characteristics of a predetermined computational task to be performed by the system.

6. The message passing fabric modular processor system of claim 5 wherein the proportions of processing element types are selected based upon the computational characteristics of a predetermined computational task to be performed by the system.

7. The message passing fabric modular processor system of claim 4 wherein the spatial arrangement of processing elements is selected based upon the computational characteristics of a predetermined computational task to be performed by the system.

8. The message passing fabric modular processor system of claim 6 wherein the spatial arrangement of processing elements is selected based upon the computational characteristics of a predetermined computational task to be performed by the system.

9. The message passing fabric modular processor system of claim 4 wherein the type, proportion, and spatial arrangement of processing elements are selected to increase the availability of processing elements under conditions of high utilization of processing elements.

10. The message passing fabric modular processor system of claim 1 wherein the length of each message path is one processing unit interconnection in one dimension of the fabric.

11. The message passing fabric modular processor system of claim 6 wherein the addressing means decodes the address of the message destination and determines the shortest next destination address within the fabric.

12. The message passing fabric modular processor system of claim 10 wherein the addressing means selects an alternative next-shortest destination address if the prior determined address is unavailable.

13. The message passing fabric modular processor system of claim 1 wherein the set of available processing elements of each processing element in the fabric is stored in a modifiable data structure.

14. The message passing fabric modular processor system of claim 13 wherein the data contained in each modifiable data structure is modified based upon the computational characteristics of a predetermined computational task to be performed by the system.

15. The message passing fabric modular processor system of claim 1 wherein the arbitration means comprises means to prevent deadlock over access to processing elements or message paths.

16. The message passing fabric modular processor system of claim 1 wherein asynchronous establishment of routes for synchronous messaging from an origin processing element to a destination processing element requires no flow control protocol to be implemented in the route from the origin processing element to the destination processing element.

17. The message passing fabric modular processor system of claim 1 wherein message collisions are detected, and contending processing elements are independent in the time domains in which each of them retries messaging is independent of the other.

18. The message passing fabric modular processor system of claim 12 wherein the path to an alternative next-shortest destination address may be orthogonal to the path to the destination address if the absolute value in the time-to-live register is positive.

19. The message passing fabric modular processor system of claim 18 wherein upon selection of an orthogonal path causes the absolute value of the time-to-live register to be decremented.

20. A method for message passing in a modular processor system comprising the steps of:
Providing a plurality of processing elements, each element accessing a set of available processing elements;
Providing a plurality of message ports in communication with each processing element, each pair of message ports on adjacent processing elements defining a message path therebetween;
Associating an addressing means with each processing element for indicating the destination of a message in the fabric;
Associating a prioritization means with each processing element and each message port for determining which message port is to be given access to the associated processing element or message port;
wherein the fabric asynchronously establishes routes for synchronous messages from an origin processing element to a destination processing element thereby permitting an operation to occur at the destination processing element.
